(19) United States
(12) Patent Application Publication
(10) Pub. No.: US 2025/0270364 A1
(43) Pub. Date: Aug. 28, 2025

(54) SYNTHESIS OF COPOLYMERS FROM HOMOPOLYMERS

(71) Applicant: Northwestern University, Evanston, IL (US)

(72) Inventors: Jeremy L. Swartz, Evanston, IL (US); Benjamin Ross Elling, Evanston, IL (US); William Robert Dichtel, Evanston, IL (US)

(21) Appl. No.: 18/858,252

(22) PCT Filed: Apr. 20, 2023
(86) PCT No.: PCT/US2023/066028

§ 371 Date: Oct. 18, 2024

Related U.S. Application Data
(60) Provisional application No. 63/333,116, filed on Apr. 20, 2022.

(51) Int. Cl. C08G 18/10; C08G 18/24; C08G 18/42

(52) U.S. Cl. CPC C08G 18/10; C08G 18/246; C08G 18/4277

(57) ABSTRACT

Disclosed herein are methods for preparing a copolymer from homopolymers. The method comprises compounding a bond-exchange catalyst and a polymer composition comprising a first homopolymer and a second homopolymer at an effective bond-exchange temperature for an effective bond-exchange time in a compounder, thereby preparing a compounded melt. Also disclosed is a method for preparing a compatibilized blend comprising compounding the copolymer prepared by a method described herein and a second polymer composition at a compatibilization temperature for a compatibilization time in a compounder.

### CROSS-REFERENCE TO RELATED APPLICATIONS

This application claims benefit of priority to U.S. Patent Application Ser. No. 63/333,116, filed Apr. 20, 2022, the contents of which is incorporated by reference in its entirety.

### STATEMENT REGARDING FEDERALLY SPONSORED RESEARCH

This invention was made with government support under CHE-1901635 awarded by National Science Foundation. The government has certain rights in the invention.

### BACKGROUND OF THE INVENTION

Although thermoplastics have been recycled since the 1970s, less than 10% of the three million tons of plastic waste generated annually are recycled.¹ 75% of plastics are landfilled,² while only 25% are either converted into fuels via pyrolysis,³ depolymerized into monomers,⁴ or close-loop recycled into post-consumer products.⁵⁻⁷ This low rate of plastic recycling is largely due to inefficient and expensive sorting techniques,⁸ synthesis of new plastic being more cost-effective, and mixed waste recycling yielding incompatible materials with deteriorated properties.⁹ Most mixtures of plastics form immiscible blends, which complicates the recycling of post-consumer waste streams or products containing more than one type of plastic. Although the majority of polymer blends are immiscible, blending thermoplastics that are miscible can provide materials that combine desirable properties of the two constituents.^{10,11} Polymers are only miscible if they are structurally similar or have low interfacial energy differences.¹²⁻¹⁵ These parameters demonstrate why most polymer mixtures are incompatible.

### BRIEF SUMMARY OF THE INVENTION

Disclosed herein are methods for preparing a copolymer from homopolymers. The method comprises compounding a bond-exchange catalyst and a polymer composition comprising a first homopolymer and a second homopolymer at an effective bond-exchange temperature for an effective bond-exchange time in a compounder, thereby preparing a compounded melt. The compounded melt may be extruded to provide the copolymer. The effective bond-exchange time and/or effective bond-exchange time may be selected, individually or collectively, to provide a block copolymer or a random copolymer. In some embodiments, the first homopolymer is a polyurethane homopolymer and the second homopolymer is a polyester homopolymer, thereby allowing for the preparation of a polyurethane/polyester block copolymer or a polyurethane/polyester random copolymer.

Also disclosed is a method for preparing a compatibilized blend comprising compounding the copolymer prepared by a method described herein and a second polymer composition at a compatibilization temperature for a compatibilization time in a compounder. The compounded melt may be extruded to provide the compatibilized blend. Compounding the second polymer composition with an effective amount of the copolymer may result in a higher degree of crystallinity in the compatibilized blend than the second polymer composition. This can improve the material properties of the compatibilized blend relative to the second polymer composition.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. (A) Copolymer synthesis via bond exchange between a PU and PE using a twin screw extruder with varying residence times during extrusion resulting in blocky structures at low extrusion times to more random-like copolymers at longer processing times. (B) Incorporation of the copolymer that results in higher degrees of crystallinity in a miscible PCL/TPU blend through the block copolymer nucleating PCL.

FIG. 2. Quantitative ¹³C NMR spectra of (A) a copolymer synthesized via extrusion of PCL and PU-1 at 200° C. with low residence time (Table 1, Entry 1), with an inset showing the carbonyl region, (B) PCL, and (C) PU-1. The carbonyl carbon signals have been labeled (1-4) to show that two new carbonyl signals were seen after extrusion due to dynamic exchange.

FIG. 3. (A) DSC heat ramps of the three blends (labeled 11-13) with varying block copolymer incorporation showing a single distinct T_{g} suggesting that these two homopolymers are miscible. (B) Optical images of the stained extruded blends and starting polymers showing that the staining increases with increasing block copolymer incorporation in the blends.

FIG. 4. (A) Endotherms of the three blends (labeled 21-23) during the initial DSC heat ramp, which increase in magnitude with increasing block copolymer incorporation. (B) XRD analysis of the three blends (labeled 24-26) with increasing crystallinity as a function of block copolymer incorporation. (C) Stress-strain curves of the starting PCL and TPU (PU-1) as well as PCL/TPU blends with different weight percentages of block copolymers (0, 5, and 10) showing that the extruded copolymer enhances the mechanical properties of the blends.

FIG. 5. (A) XRD analysis of blends containing different copolymers (labeled 31-33) showing that crystallinity changes as a function of the copolymer architectures. (B) Stress-strain curves of the blends with 10 wt % of the three different copolymers (labeled 34-36), resulting from different extrusion residence times, incorporated showing that the mechanical properties of the blends are dependent upon the length of the blocks as well as molecular weight of the copolymers.

FIG. 6. (A) XRD analysis of blends with different amounts of block-like copolymer after heating (labeled 41-43) showing that the copolymer containing blends are still crystalline after heating. (B) DSC heat ramp of blend without copolymer (44) and the blend with containing 10 wt % of copolymer 4 (45) which contains a cold crystallization exotherm that is not present in the DSC trace without the copolymer. (C) Tensile testing of the blend with 10 wt % of copolymer 4 showing the effect of extrusion on the mechanical properties of the blend (46) and that the mechanical properties are regained after melting of the extruded materials (47) followed by reextrusion of the blend (48).

FIG. 7. GPC traces for reprocessed copolymers following recirculation times of 0 min (Table 1, Entry 1), 10 min (Table 1, Entry 4), 20 min (Table 1, Entry 5), and 30 min (Table 1, Entry 6).

FIG. 8. GPC traces for two PU-1s (labeled 51 and 52) synthesized under identical conditions to show reproducibility of the method, PCL (53), and a reprocessed copolymer (Table 1, Entry 1, 54).

FIG. 9. DSC traces for PU-1 (61), PCL (62), and a reprocessed copolymer (Table 1, Entry 1, 64).

FIG. 10. ¹³C NMR spectra comparing the polymer mixture before and after extrusion showing that the only new peaks arising are the new exchange products and that the integrals of the carbonyls are the same before and after extrusion suggesting no side reactions.

FIG. 11. GPC chromatogram of PCL: PU-1 blend containing 10 wt % of copolymer showing a bimodal distribution resulting from no exchange during the extrusion of the blend.

FIG. 12. Transmission electron microscopy of cross-sectioned portions of the 5 wt % block copolymer film stained with RuO₄ showing one phase is present in the PU-1/PCL blends with block copolymer.

FIG. 13. Transmission electron microscopy of cross-sectioned portions of the 0 wt % block copolymer film stained with RuO₄ showing one phase is present in the PU-1/PCL blends without block copolymer.

FIG. 14. XRD spectra for the extruded PCL (71) and extruded PU-1 (72) showing that the PCL is semi-crystalline and the PU-1 does not have those crystalline regions.

FIG. 15. DSC traces for the initial heat ramps of the 10 wt % blends with different recirculated copolymers incorporated (labeled 81-83) showing that the 10 wt % 10 minute blend has the most crystallinity after the blend is extruded.

FIG. 16. DSC trace for the blend containing 10 wt % of copolymer 4 after heating and reextrusion showing the ability for the blend to regain the majority of the crystallinity after reextrusion.

FIG. 17. XRD spectra of 10 wt % blend with copolymer 4 after the first extrusion (91), heat treatment (92), and reextrusion (93).

FIG. 18. DSC traces for reprocessed copolymers synthesized via varying recirculation time (labeled 101-103).

FIG. 19. DSC second heating traces of the blends containing different copolymers 1 (111), 4 (112), and 6 (113) showing the difference in cold crystallization between the different blends.

FIG. 20. Quantitative ¹³C NMR of PCL/TPU extruded with 0.5 wt % of DBTDL at 200 degrees on flush (Table 1, Entry 1).

FIG. 21. Quantitative ¹³C NMR of PCL/TPU extruded with 1.0 wt % of DBTDL at 200 degrees on flush (Table 1, Entry 2).

FIG. 22. Quantitative ¹³C NMR of PCL/TPU extruded with no catalyst at 200° C. on flush (Table 1, Entry 3).

FIG. 23. Quantitative ¹³C NMR of PCL/TPU extruded with 0.5 wt % of DBTDL at 200° C. which was recirculated for 10 minutes (Table 1, Entry 4).

FIG. 24. Quantitative ¹³C NMR of PCL/TPU extruded with 0.5 wt % of DBTDL at 200° C. which was recirculated for 20 minutes (Table 1, Entry 5).

FIG. 25. Quantitative ¹³C NMR of PCL/TPU extruded with 0.5 wt % of DBTDL at 200° C. which was recirculated for 30 minutes (Table 1, Entry 6).

FIG. 26. Quantitative ¹³C NMR of PCL/TPU extruded with 0.5 wt % of DBTDL at 120 degrees on flush (Table 1, Entry 7).

FIG. 27. Quantitative ¹³C NMR of PCL/TPU extruded with 0.5 wt % of DBTDL at 150 degrees on flush (Table 1, Entry 8)

FIG. 28. Quantitative ¹³C NMR of PCL/TPU extruded with 0.5 wt % of DBTDL at 180 degrees on flush (Table 1, Entry 9).

FIG. 29. Quantitative ¹³C NMR of PCL/TPU extruded with 0.5 wt % catalyst at 220° C. on flush (Table 1, Entry 10).

### DETAILED DESCRIPTION OF THE INVENTION

Disclosed herein is the synthesis of copolymers from homopolymers. The Examiner demonstrate the synthesis of thermoplastic polyurethane (TPU)/polyester (PE) copolymers via ester/urethane bond exchange between TPU and PE homopolymers during their coextrusion in the presence of a catalyst. Covalent scrambling by dynamic exchange was supported by the observation of a monomodal GPC chromatogram for the blended polymer. The structures of the new copolymers were characterized by quantitative ¹³C NMR spectroscopy. Extrusion time and temperature affected the extent of exchange, with shorter residence time and lower temperatures giving limited bond exchange and blocky copolymers. In contrast, longer extrusion times and higher temperatures provided more extensive exchange and approximately random copolymers. Coextruded mixtures of TPU and PE homopolymers with varying amounts of copolymers demonstrated improved tensile stress and strain relative to coextruded mixtures of TPU and PE alone due to enhanced crystallization of the miscible homopolymer blend facilitated by the added copolymer compatibilizer. This approach represents a simple and general strategy for obtaining copolymers from homopolymers rather than using specialized polymerization techniques, allowing for products from mixed polymer waste to be used as compatibilizers or otherwise enhance the properties of the original homopolymers mixtures.

### Definitions

Several definitions are provided to assist with the understanding of the technology.

“Block” means a portion of a macromolecule, comprising many constitutional units, that has at least one constitutional or configurational feature which is not present in the adjacent portions.

“Branch” means an oligomeric or polymeric offshoot from a macromolecular chain.

“Branch point” means a point on a chain at which a branch is attached.

“Branch unit” means a constitutional unit containing a branch point.

“Catalyst” means a substance that increases the rate of a reaction without modifying the overall Gibbs energy change in the reaction. Suitably the catalyst may be a coordination entity comprising a central atom and one or more ligands joined to the central atom. Suitably the central atom is a metal. “Ligand” means an atom or group joined to a central atom.

“Chain” means a whole or part of a macromolecule, an oligomer molecule, or a block, comprising a linear or branched sequence of constitutional units between two boundary constitutional units, each of which may be either an end-group, a branch point, or an otherwise-designated characteristic feature of the macromolecule.

“Compatibilization” means a process of modification of the interfacial properties in an polymer blend that results in formation of the interphases and stabilization of the morphology. Compatibilization may be accomplished by adding a copolymer to a polymer composition. The copolymer may be added to the polymer composition in an amount of less than 20 wt %. Suitably, the copolymer may be added to the polymer composition in an amount of 1-20 wt %, 1-15 wt %, 1-10 wt %, or 1-5 wt %. The copolymer may be prepared from the polyurethane and polyester homopolymers by the methods described herein.

“Compatibilization temperature” means a temperature sufficient for compatibilization of a copolymer and polymer composition comprising a first homopolymer and a second homopolymer. In some embodiments, the compatibilization temperature is between 50° C. and 300° C. Suitably the effective bond-exchange temperature may be greater than or equal to 75° C. or 125° C. and/or less than or equal to 250° C., 225° C., 200° C., 175° C., 150° C., or 125° C.

“Compatibilization time” means a time sufficient for compatibilization. In some embodiments, the compatiblization time is less than or equal to 60 minutes. Suitably the effective bond-exchange time may be less than 50 minutes, 45 minutes, 40 minutes, 35 minutes, 30 minutes, 25 minutes, 20 minutes, 15 minutes, 12 minutes, 10 minutes, 9 minutes, 8 minutes, 7 minutes, 6 minutes, 5 minutes, 4 minutes, 3 minutes, or less than 2 minutes.

“Compatibilized blend” means an polymer blend that that exhibits macroscopically uniform physical properties by compatibilization. The compatibilized blend may be prepared by adding a copolymer prepared by the methods described herein to a polymer composition.

“Compounding” means to blend or mix a substance, such as any of the polyurethane compositions described herein, within a compounding device. Suitably the substance is compounded at an effective bond-exchange temperature for an effective bond-exchange time.

“Compounding device” means a device for blending or mixing a substance, such as any of the polyurethane compositions described herein. In some embodiments, the compounding device is an extruder, such as a single screw or twin-screw extruder, a mixer, or a kneader. Suitably twin-screw extruders may be a co-rotating or counter-rotating twin-screw extruder. The compounding device may operate in batch or continuous service. Suitably a continuous service compound device may have an inlet, such as a feeding hopper or other suitable feeding mechanism, for introducing the substance into the compounding device, an outlet for extruding the compounded substance, and a compounding zone between the inlet and the outlet for mixing or blending the substance. Suitably the compounding zone is configured so that the substance may be compounded for an effective bond-exchange time. The compounding device may also comprise a heating element so that the substance may be compounded at an effective bond-exchange temperature.

“Constitutional unit” means an atom or group of atoms (with pendant atoms or groups, if any) comprising a part of the essential structure of a macromolecule, an oligomer molecule, a block, or a chain.

“Copolymer” means a polymer derived from more than one species of (real, implicit, or hypothetical) monomer.

“Covalent network” or “covalent polymer network” means a network in which the permanent paths through the structure are all formed by covalent bonds.

“Dynamic network” or “dynamic polymer network” or “covalent adaptable network” means a covalent network that is capable of undergoing bond-exchange reactions at a temperature above an effective bond-exchange temperature. A dynamic network may demonstrate viscoelastic liquid properties above the freezing transition temperature.

“Effective amount of a bond-exchange catalyst” means an amount of bond-exchange catalyst necessary for transesterification/transcarbamoylation reactions to occur within an effective bond-exchange time at an effective bond-exchange temperature. In some embodiments, the mol % of the bond-exchange catalyst to the total isocyanate functionality may be less than or equal to 5 mol %. Suitably, the mol % may be less than or equal 4 mol %, 3 mol %, 2 mol %, 1 mol %, or less than 1 mol %. Some materials may contain small amounts of residual catalyst from their manufacture, often 0.1 mol % or less. Such limited quantities of catalyst are typically not enough to enable dynamic bond exchange on a practical time scale. As a result, the effective amount of bond-exchange catalyst may be increased post-synthetically by the methods described herein such as swelling or direct mechanical mixing.

“Effective bond-exchange temperature” means a temperature above the freezing transition temperature. The “freezing transition temperature” is the temperature where a material transitions from a viscoelastic solid to a viscoelastic liquid. The effective bond-exchange temperature is lower than the temperature where the dynamic network undergoes irreversible thermal instability or degradation. In some embodiments, the effective bond-exchange temperature is between 100° C. and 300° C. In some embodiments, the effective bond-exchange temperature is greater than the freezing transition temperature and less than or equal to 275° C. Suitably the effective bond-exchange temperature may be less than or equal to 250° C., 225° C., 200° C., 190° C., 180° C., 170° C., 160° C., 150° C., 140° C., 130° C., 120° C., 110° C., or less than 110° C.

“Effective bond-exchange time” means a time sufficient for bond exchange reactions to occur. The effective bond-exchange time may be determined by monitoring the stress decay of a composition. Suitably, a minimum effective bond-exchange time may be determined as the time necessary for the stress relaxation modulus to relax to at least 37% (1/e) of its initial value. In some embodiments, the effective bond-exchange time is less than or equal to 60 minutes. Suitably the effective bond-exchange time may be less than 50 minutes, 45 minutes, 40 minutes, 35 minutes, 30 minutes, 25 minutes, 20 minutes, 15 minutes, 12 minutes, 10 minutes, 9 minutes, 8 minutes, 7 minutes, 6 minutes, 5 minutes, 4 minutes, 3 minutes, or less than 2 minutes.

“Foam” means a multiphasic material comprising gas dispersed in a polymer. The foam may be formed by trapping pockets of gas in a solid or liquid. Foams may be prepared by physical or chemically blowing. In some embodiments, the foam may be a closed-cell foam where the gas forms discrete, completely surrounded pockets. In other embodiments, the foam may be an open-cell foam where the gas pockets are interconnected. Suitably the polymer is a polyurethane (“polyurethane foam”).

“Homopolymer” means a polymer derived from one species of (real, implicit or hypothetical) monomer. Polymers may be made by the mutual reaction of complementary monomers. These monomers can readily be visualized as reacting to give an ‘implicit monomer’ or ‘hypothetical monomer’, the homopolymerization of which would give the actual product, which can be regarded as a homopolymer.

“Immiscible polymer blend” means a polymer blend that exhibits immiscibility. “Immiscibility” means an inability of a mixture to form a single phase.

“Inorganic polymer” means a polymer or polymer network with a skeletal structure that does not include carbon atoms. Examples include, without limitation, polyphosphazenes, polysilicates, polysiloxanes, polysilanes, polysilazanes, polygermanes, and polysulfides.

“Isocyanate constitutional unit” means a constitutional unit comprising at least one isocyanate group, i.e., —NCO. Suitably the isocyanate constitutional unit may comprise more than one isocyanate group such as two, three, or four isocyanate groups. In some embodiments, the isocyanate constitutional unit is an aromatic isocyanate constitutional unit. As used herein, an “aromatic isocyanate constitutional unit” means an isocyanate constitutional unit having an isocyanate group pendant from an aryl group such a phenyl or other aromatic ring.

“Lewis acid” means a molecular entity (and the corresponding chemical species) that is an electron-pair acceptor and therefore able to react with a Lewis base to form a Lewis adduct, by sharing the electron pair furnished by the Lewis base.

“Linear chain” means a chain with no branch points between the boundary units.

“Macromolecule” or “polymer molecule” means a molecule of high relative molecular mass, the structure of which essentially comprises the multiple repetition of units derived, actually or conceptually, from molecules of low relative molecular mass.

“Mechanically processed” means to mechanically alter a substance, e.g., by mechanically grinding, cutting, chopping, or applying some other form of mechanical force. Suitably, the substance such as the polyurethane compositions described herein may be mechanically processed to fragment the substance into pieces or grains.

“Monomer” means a substance composed of monomer molecules.

“Monomer molecule” means a molecule which can undergo polymerization, thereby contributing constitutional units to the essential structure of a macromolecule.

“Monomeric unit” means the largest constitutional unit contributed by a single monomer molecule to the structure of a macromolecule or oligomer molecule.

“Network” means a highly ramified macromolecule in which essentially each constitutional unit is connected to each other constitutional unit and to the macroscopic phase boundary by many permanent paths through the macromolecule, the number of such paths increasing with the average number of intervening bonds; the paths must on the average be co-extensive with the macromolecule.

“Network polymer” means a polymer composed of one or more networks.

“Oligomer molecule” means a molecule of intermediate relative molecular mass, the structure of which essentially comprises a small plurality of units derived, actually or conceptually, from molecules of lower relative molecular mass.

“Organic polymer” means a polymer or polymer network with a skeletal structure that includes carbon atoms. Examples include, without limitation, polyethers, polyesters, polycarbonates, polyacrylates, polyolefins, and polybutadienes.

“Polymer” means a substance composed of macromolecules.

“Polymer composition” means a composition comprising two or more different homopolymers. The homopolymers may have reactive chemical moieties that can undergo bond exchange. The two or more different homopolymers may be selected from two or more different classes of polymers, such as polyurethanes, polyesters, and polycarbonates. The two or more different homopolymers may be between 20 and 80 wt % the polymer composition For two different homopolymers, the weight ratio of the first homopolymer and second homopolymer may be between 20:80 and 80:20, 25:75 and 75:25, 30:70 and 70:30, 35:65 and 65:35, 40:60 and 60:40, 45:55 and 55:45, or about 50:50. The polymer composition may be a miscible or immiscible polymer blend.

In some instances, the polymer composition comprises a polyurethane homopolymer and a polyester homopolymer. The weight percent (wt %) of the polyurethane homopolymer is between 20 and 80 wt % and the weight percent of the polyester homopolymer is between 20 and 80 wt % in the polymer composition The weight ratio of the polyurethane homopolymer and polyester homopolymer may be between 20:80 and 80:20, 25:75 and 75:25, 30:70 and 70:30, 35:65 and 65:35, 40:60 and 60:40, 45:55 and 55:45, or about 50:50.

“Polymerization” means a process of converting a monomer or a mixture of monomers into a polymer.

“Prepolymer molecule” means a macromolecule or oligomer molecule capable of entering, through reactive groups, into further polymerization, thereby contributing more than one constitutional unit to at least one type of chain of the final macromolecules.

“Polyurethane composition” means a dynamic network formed from urethane bonds that are capable of undergoing urethane bond-exchange reactions. The polyurethane compositions comprise a network urethane-containing polymer and a polyurethane exchange catalyst permeated within the network polymer. The network polymer may be formed from isocyanate constitutional units and a second constitutional unit having hydroxyl groups capable of reacting with the isocyanate group of the isocyanate constitutional unit. The mol % of the polyurethane exchange catalyst to the total isocyanate functionality may be less than or equal to 5 mol %. Suitable, the mol % may be less than or equal 4 mol %, 3 mol %, 2 mol %, 1 mol %, or less than 1 mol %. The second constitutional unit may be a prepolymer molecule or a branch unit. Suitably the second constitutional unit may function as both a prepolymer molecule and a branch unit. The prepolymer molecule is an organic polymer molecule or an inorganic polymer molecule such as a polyether, a polyester, a polycarbonate, a polyacrylate, a polyolefin, a polybutadiene, a polysulfide, or a polysiloxane having one or more hydroxyl groups capable of reacting with an isocyanate group. When the prepolymer molecule also functions as a branch unit, the prepolymer molecule has a three or more hydroxyl groups capable of reacting with isocyanate groups and typically a plurality of hydroxyl groups in proportion to the number of constitutional units of the prepolymer molecule. The network polymer may also be formed from urethane-containing monomers featuring other polymerizable groups, including but not limited to, acrylates, methacrylates, or other polymerizable olefins.

“Bond-exchange catalyst” means a catalyst that increases the rate of a bond-exchange reaction, such as a polyurethane bond exchange reaction. Suitable metal for the catalyst includes Sn, Bi, Fe, Zr, Ti, Hf, Al, Zn, Cu, Ni, Co, Mn, V, Sc, Y, Ce, or Mo. Suitable ligands for the catalyst include, without limitation, branched or unbranched, substituted or unsubstituted carboxylates, alkyls, alkoxides, 1,3-diketones, 1,2-diketones, sulfonates, sulfonamides, amines, diamines, carbonates, phosphates, nitrates, halides, catecholates, hydroxamates, hydroxides, or any combination thereof. The ligand may be branched or unbranched, substituted or unsubstituted. Exemplary ligands include acetylacetonate (acac), isopropoxide (OiPr), neodecanoate (neo), laurate, butyl, ethylhexanoate, and 2,2,6,6-Tetramethyl-3,5-heptanedione (tmhd), trifluoromethanesulfonate, trifluoromethanesulfonamide, cyclopentadiene, pyridine salicylidene diamine, phosphine, or any combination thereof. Exemplary catalysts include, without limitation, dibutyltin dilaurate (DBTDL), Bi(neo)₃, Fe(acac)₃, Ti(OiPr)₂(acac)₂, Hf(acac)₄, Zr(acac)₄, Mn(acac)₂, Bi(oct)₃, Zn(tmhd)₂, Zr(tmhd)₄, or any combination thereof.

“Thermosetting polymer” or “thermoset” is a polymer that is irreversibly hardened by curing from a soft solid of viscous liquid prepolymer or resin.

“Vitrimer” means a network polymer that can change its topology by thermally activated bond-exchange reactions. At elevated temperatures, the bond-exchange reactions occur at an effectively rapid rate and the network polymer has properties of a viscoelastic liquid. At low temperatures, the bond-exchange reactions are slowed and the network polymer behaves like a thermosetting polymer.

Synthesis of Copolymers from Homopolymers

Copolymers are used in many fields, from nanolithography to thermoplastic elastomers.^{16,17} Copolymers have also been used to enhance properties of immiscible polymers through compatibilization. Often, copolymers are made through precise, sequential living polymerizations of monomers,¹⁸ which give the highest level of structural control resulting in defined microstructures. Multiblock structures require specialized catalysts to enchain both monomers without deleterious side reactions.¹⁹⁻²¹ Here a new approach is introduced to access multiblock copolymers derived from two homopolymers. This method is solvent-free and involves the melt processing and dynamic exchange between two thermoplastics. The microstructure of the resulting copolymers is tunable from blocky structures to random copolymers.

Copolymers, especially multiblock copolymers can compatibilize immiscible polymer blends.²²⁻²⁴ The copolymers reduce the interfacial tension between the two phases, resulting in greater homogeneity and improved properties. A notable successful compatibilization approach was reported by Bates, Coates, Lapointe, and their coworkers, who demonstrated that polyethylene (PE) and isotactic polypropylene (iPP) showed higher toughness and strains at break when compatibilized with as little as 5 wt % of a multiblock PE-iPP copolymer.²⁵⁻²⁷ While copolymer addition has been explored as a means to compatibilize immiscible blends, it has not previously been shown to enhance the properties of miscible polymer blends. Here we show that polyurethane/polyester miscible blends are further enhanced through the incorporation of copolymers derived from the starting two homopolymers using this simple solvent-free copolymer synthesis. Thermal analysis and x-ray diffraction show that the copolymer enhances the nucleation of the polymer crystallites resulting in enhanced properties. Combined with the synthesis of the copolymers, this approach demonstrates property enhancement of miscible polymer blends while also potentially synthesizing copolymers to compatibilize immiscible polymer blends.

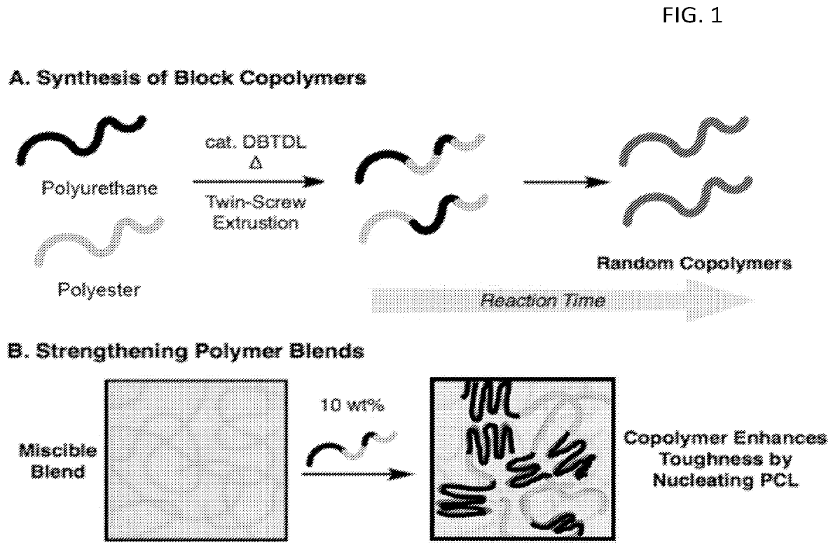

Here a new approach is developed to access copolymers. In an aspect of the invention, the method comprises compounding a bond-exchange catalyst and a polymer composition comprising a polyurethane homopolymer and a polyester homopolymer at an effective bond-exchange temperature for an effective bond-exchange time in a compounder, thereby preparing a compounded melt and extruding the compounded melt from the compounder. The copolymer may consist of PU and PE segments directly from a mixture of the two homopolymers by adding catalysts capable of exchange among both carbamates and esters (FIG. 1A). The weight percent of the first homopolymer to the second homopolymer may be from about 20:80 to 80:20.

Dibutyltin dilaurate (DBTDL) catalyzes both urethane exchange and transesterification reactions to scramble a mixture of a polyurethane and a polyester into copolymers. This process was performed in the absence of solvent by co-extruding the polyester and polyurethane homopolymers in the presence of DBTDL at elevated temperatures. The melt temperature can be between 100 to 300° C.

The copolymer structure was modified by varying the residence times during extrusion to allow for block copolymers at lower processing times to random copolymers at longer processing times. The residence time is selected from about 1 to 60 minutes. The resulting copolymers are soluble in organic solvents, which enables structural characterization by solution NMR.

This method also gives direct insight into catalyst activity during extrusion. Once characterized, the copolymers were used to enhance mixtures of the homopolymers through increasing the mechanical properties of the blends by increasing the material's crystallinity (FIG. 1B). Copolymers of differing structures ranging from blocky to random were also incorporated into the blends and the block length and molecular weight were found to have effects on the resulting mechanical properties of the blends. These results developed a method for producing tunable copolymers from two waste thermoplastics as well as demonstrated the mechanical enhancement and increasing crystallinity of the blends due to copolymer incorporation.

In another aspect of the invention, a method for preparing a compatibilized blend comprises compounding the polyurethane/polyester copolymer prepared by the methods described herein with a polymer composition comprising a polyurethane homopolymer and a polyester homopolymer at a compatibilization temperature for a compatibilization time in a compounder, thereby a compatibilized blend, and extruding the compatibilized blend from the compounder. The second polymer composition may be compounded with an effective amount of the copolymer to resent in a higher degree of crystallinity in the second polymer composition or modulate the mechanical or elastomeric properties of the composition. Suitably, compounding the copolymer with the second polymer composition may alter the tensile stress, strain at break, Young's modulus, or toughness.

### Synthesis and Characterization of Linear Polyurethane.

We selected linear polycaprolactone (PCL, Mₙ=80 kDa) as the polyester used in this study due to its commercial availability and low melting point of 60° C. We designed PU-1, which contains an aromatic backbone, so as to distinguish its carbamates from the aliphatic carbamates formed upon exchange with PCL within a ¹³C NMR spectrum. A Williamson ether synthesis using S-1 and 1-bromooctane provided ether (S-2) in good yield.³⁰ S-2 was reduced to the corresponding diol S-2 using LiAlH₄ in excellent yield. PU-1 was synthesized via step-growth polymerization of diol S-2 and methylene diphenyl diisocyanate (MDI), a commonly used PU monomer. This polymerization was catalyzed by dibutyltin dilaurate (DBTDL), which catalyzes both synthesis of urethanes as well as the thermal reversion of urethanes back into alcohols and isocyanates.³¹ After polymerizing in THF at 60° C. for 24 h, PU-1 was precipitated into MeOH and isolated as a white powder.

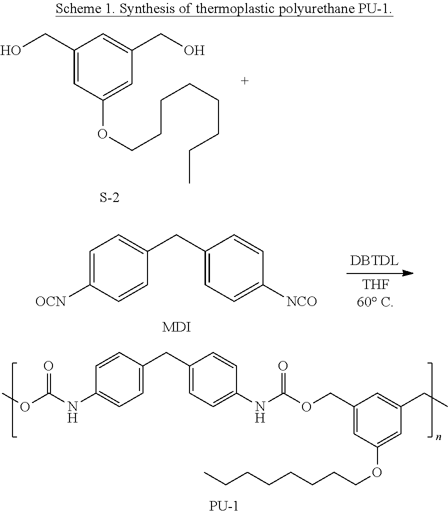

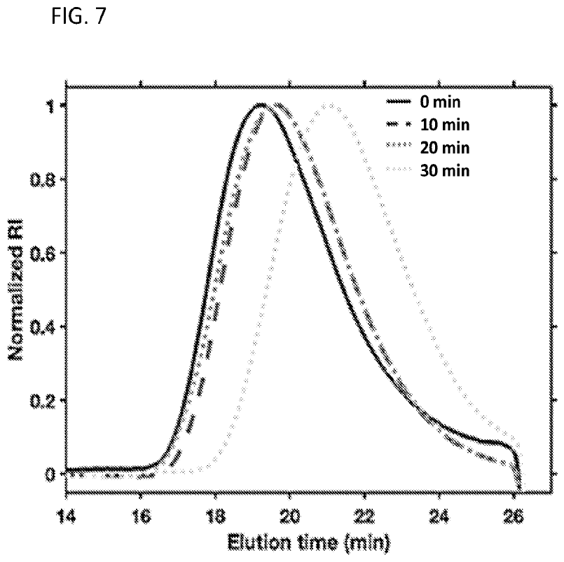

The GPC chromatogram of DMF-soluble PU-1 showed a monomodal distribution with a moderate Ð of 1.33. Multiangle static light scattering (MALS) analysis suggested an Mₙ of 22.1 kDa. Subsequent polymerizations yielded polymers with similar Ðs and Mₙs (FIG. 7). A 1:1 ratio of CDCl₃ and DMSO-d₆ was used for NMR analysis as this solution dissolved both PU-1 and PCL. The ¹H NMR spectrum of PU-1 exhibited the anticipated signals, including a broad singlet at 9.53 ppm, corresponding to the proton bonded to the urethane nitrogen. To perform quantitative ¹³C NMR spectroscopy, a solution of Cr(acac)₃ was added as a paramagnetic relaxation agent. An inverse gated decoupling pulse sequence was used to avoid Nuclear Overhauser Effect build up during acquisition. The resulting quantitative ¹³C NMR spectrum of PU-1 showed the carbonyl signal at a chemical shift of 153.3 ppm, which was well resolved from PCL's carbonyl resonance at 172.6 ppm.

### Synthesis of Copolymers via Twin Screw Extrusion.

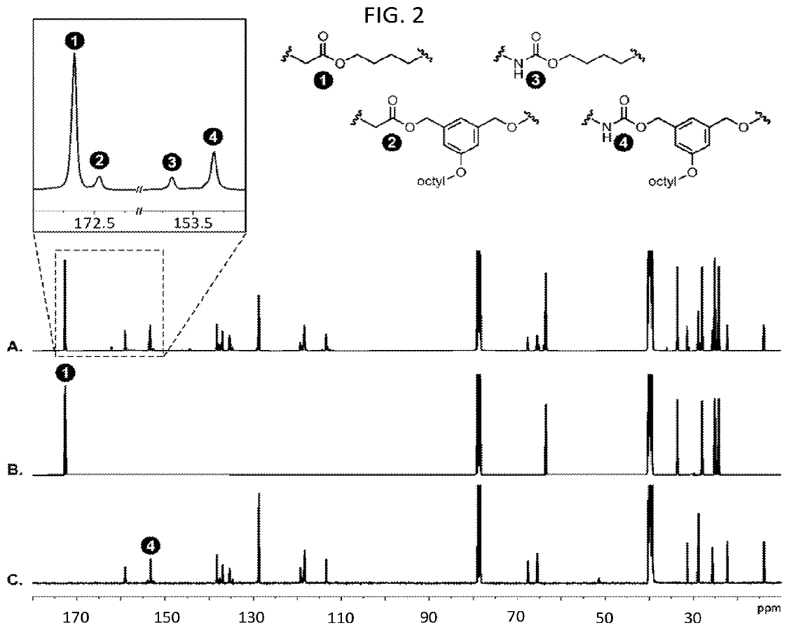

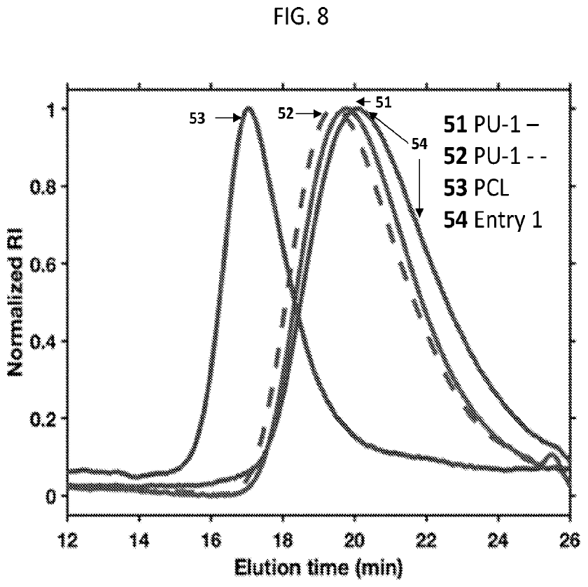

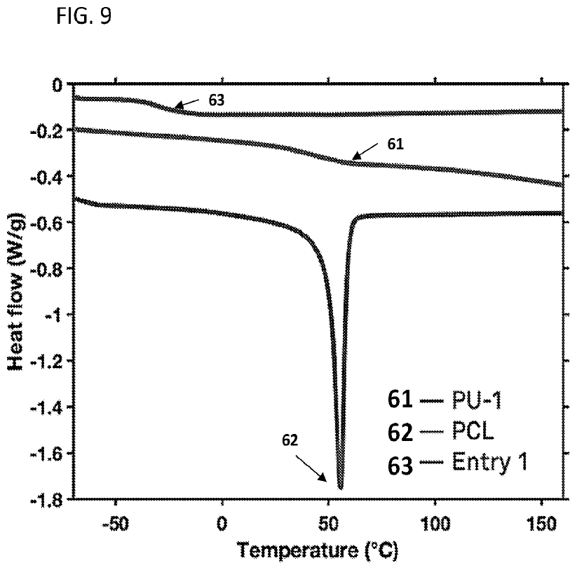

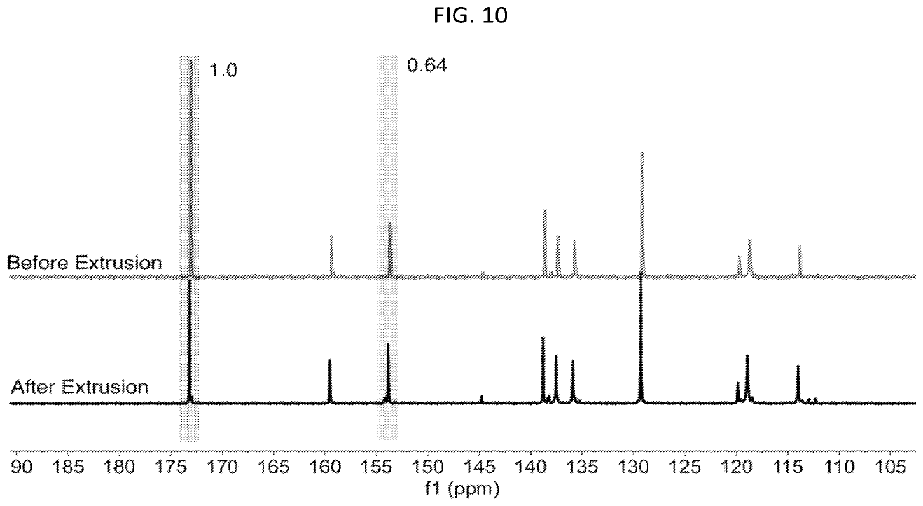

We characterized the extent of bond exchange between polycaprolactone and PU-1 and subsequently the average degree of polymerization (DPₙ) of each segment in the extruded copolymers via quantitative ¹³C NMR spectroscopy. Equal masses of PCL and PU-1 were combined along with DBTDL (0, 0.5, or 1 wt %) in a solution of DCM, which corresponded to a 2.3:1 molar ratios of ester: carbamate groups in the polymer mixtures. Following removal of the solvent, the mixture was loaded into a twin screw extruder, which was heated to 200° C. with the screws rotating at 150 rpm. The polymers moved through the extruder with specific residence time of 2 minutes. SEC analysis of the extruded polymer showed a monomodal peak with a calculated Mₙ of 16.7 kDa and a Ð of 1.72 (FIG. 8). No peaks in the chromatogram corresponded to either PCL or PU-1, suggesting that all polymers reacted to form new copolymers. This finding was also consistent with differential scanning calorimetry (DSC), which showed that the resulting copolymers had one T_{g} around −13° C. which was between the T_{g}s of PCL (−60° C.) and PU-1 (56° C.) (FIG. 9). ¹³C NMR spectroscopy showed the original carbamates and ester carbonyl resonances, as well as at 172.6 and 153.3 ppm, new peaks corresponding to new ester and urethane carbonyl carbons at 172.5 and 153.7, respectively (FIGS. 2, 10). The new urethane carbonyl resonance, whose peak is at 153.7 ppm, corresponds to the carbamate formed between an aliphatic alcohol derived from PCL and an isocyanate formed from carbamate reversion of PU-1. The new ester carbonyl, whose peak is at 172.5 ppm, results from the free PU-1 alcohol reacting with the ester in the polycaprolactone. Co-extrusion of PCL and PU-1 in the presence of a carbamate exchange catalyst yielded copolymers whose bond exchange can be directly characterized by quantitative ¹³C NMR spectroscopy.

Using the NMR integrations in the quantitative ¹³C NMR spectrum, the amount of exchange in the extruded product was determined, which gives insight into the microstructure of the resulting copolymers. If the two polymers are fully consumed and undergo exhaustive exchange, a random copolymer will be formed. If exchange is less prevalent, multiblock microstructures are formed. For the conditions of low residence time (2 min), low catalyst amount (0.5 wt %), and extrusion temperature of 200° C., the percentage of urethane resulting from bond exchange was 25% (Table 1, Copolymer 1). It should be noted that, given an initial ratio of ˜2.3:1, if all original urethanes underwent exchange with the esters, the maximum percentage of esters being the exchange product would be 43%. With the ratios of original and exchange carbonyl signals from the ¹³C NMR spectrum, for this first copolymer, the molecular weight for the PCL and PU-1 blocks was calculated to be an average of 1065 and 1033 Da, respectively (Table 2), giving an average DPₙ of 9.33 units for PCL and 1.96 units for PU-1. Comparing this exchange product to the extruded copolymer where no catalyst was added prior to extrusion, the amount of exchange decreases as shown by only a small amount (9%) of new urethane in the product. Additionally, these polymers have longer block lengths, with a DPₙ of 33.87 units for PCL and 6.76 units for PU-1. The difference in block lengths of the exchange products shows the importance of DBTDL to catalyze both transesterification and transcarbamoylation.

TABLE 1
Copolymers of PCL and PU-1 formed via dynamic
exchange using a twin screw extruder.

| | | | DBTDL | | Average Mₙ of |
|---|---|---|---|---|---|
| Copolymer | Temperature | Residence | amount (wt | New urethane | PU-1 Block |
| Sample | (° C.) | time (min)^{a} | %) | carbonyl (%)^{b} | (Da) |
| 1 | 200 | 2 | 0.5 | 25 | 1033 |
| 2 | 200 | 2 | 1 | 21 | 1517 |
| 3 | 200 | 2 | 0 | 9 | 3555 |
| 4 | 200 | 10 | 0.5 | 58 | 423 |
| 5 | 200 | 20 | 0.5 | 66 | 402 |
| 6 | 200 | 30 | 0.5 | 71 | 370 |
| 7 | 120 | 2 | 0.5 | 0 | N/A |
| 8 | 150 | 2 | 0.5 | 6 | 5530 |
| 9 | 180 | 2 | 0.5 | 10 | 2896 |
| 10 | 220 | 2 | 0.5 | 66 | 408 |

All experiments were performed at 150 rpm.
^{a}Time that the sample spent in extruder.
^{b}Calculated from the carbonyl signals in the quantitative ¹³C NMR spectra.

Lowering the extrusion temperature yielded copolymers with less exchange between PCL and PU-1. No urethane exchange was detected by ¹³C NMR spectroscopy when the temperature of the reaction was decreased to 120° C. with 0.5 wt % DBTDL and an extruder residence time of 2 minutes. Raising the extrusion temperature to 150 and 180° C. resulted in modest exchange, with 6 and 10% new urethane detected, respectively. Therefore, these copolymers had longer average block segments than the copolymer extruded at 200° C. As anticipated, heating the system to 220° C. showed a significant increase in exchange, with 66% of all urethanes having undergone exchange to have a PCL-derived alcohol component. Overall, varying the temperature during extrusion yielded copolymers with tunable extent of exchange and block lengths, with higher temperatures resulting in more exchange and a more random copolymer and lower temperatures resulting in less exchange and block copolymers.

We next varied the residence time during extrusion and found that the average block lengths for the PCL and PU segments decreased with increasing residence time (Table 1). As the average block lengths decrease, the more extensively exchanged samples have structures approaching being random copolymers. While keeping catalyst loading and temperature constant, we coextruded the two homopolymers with 0.5 wt % of catalyst for 10, 20, and 30 min at 200° C., resulting in copolymers 4, 5, and 6 respectively. 10 min residence time showed a significant increase in the amount of new urethane formed, from 25% at 2 min (copolymer 1) to 58% at 10 min (copolymer 4). Subsequent increases in residence times resulted in more modest increases in exchange, with 20 (copolymer 5) and 30 min (copolymer 6) residence times leading to 66 and 71% of exchanged carbamates, respectively. The GPC traces for copolymer 4 and 5 showed minimal effects on molecular weight, suggesting that at these short reaction times, undesirable side reactions do not result in significant decreases in polymer length (FIG. 7). However, for copolymer 6, the Mₙ of the copolymer decreased to 5.9 kDa, suggesting chain scission on this timescale. The increased exchange resulting from longer reaction times gives copolymers that have near random structures, as the average DPₙ of the PU-1 segments approaches 1. Such samples have very short urethane segments or even isolated carbamate groups along the PCL backbone. These results demonstrate the formation of copolymers with tunable microstructures, ranging from block to random copolymers, based on reaction time, resulting from dynamic exchange of two homopolymers.

### Properties of PCL/PU-1 Polymer Blends

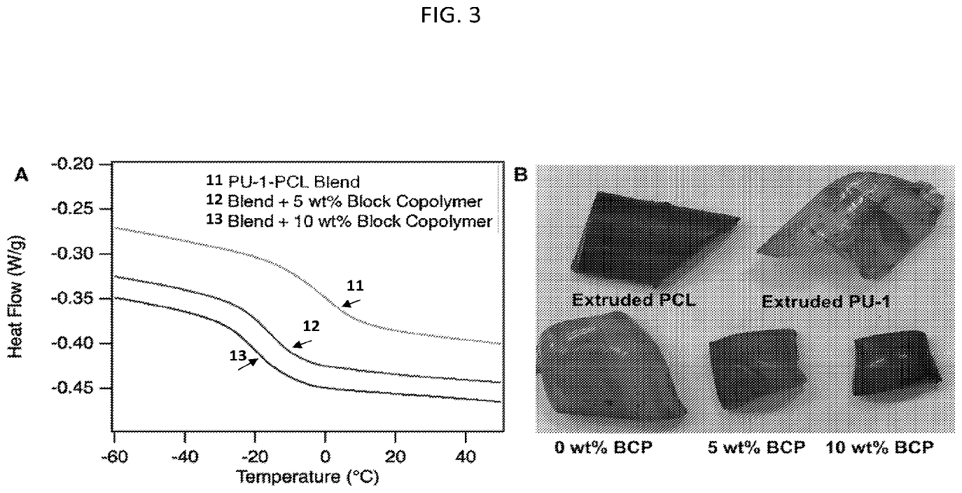

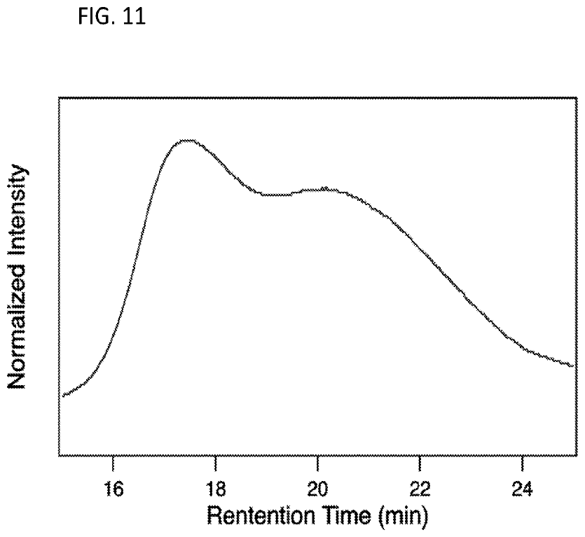

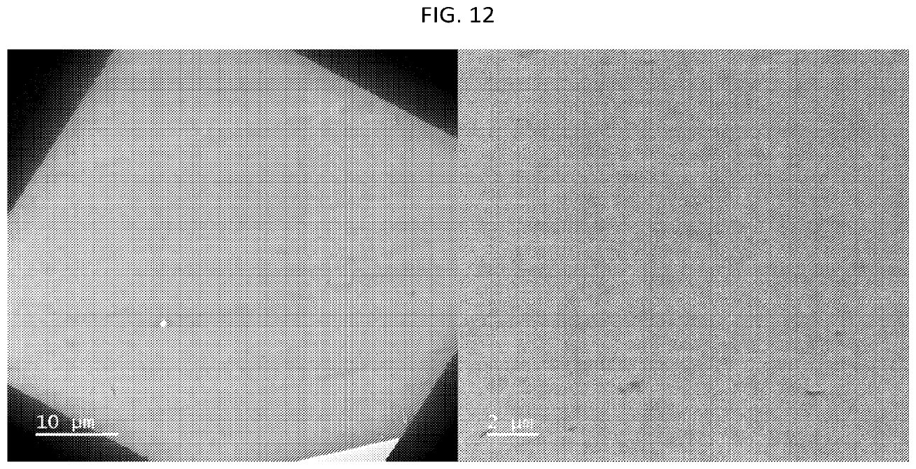

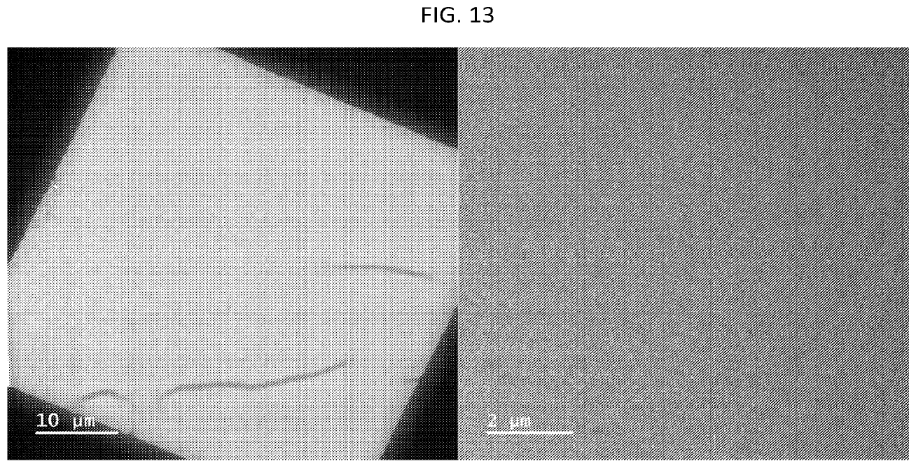

When copolymer 1 was incorporated into blends of PCL and PU-1, the crystallinity of the polymer blend increased in a dose-dependent fashion. PCL and PU-1 (50:50 wt %) mixed then coextruded with varying amounts of block copolymer 1 (0, 5, or 10 wt %). The extrusion was performed at 120° C. and no additional exchange catalyst was added in order to minimize urethane/ester exchange and instead characterize how the copolymers influenced the thermomechanical properties of homopolymer blends. Analysis of GPC chromatograms supported that no additional exchange occurred with the presence of two peaks corresponding to the starting homopolymers (FIG. 11). DSC of this blend displayed a single T_{g} between the T_{g}s of the starting PCL and PU-1, and close to the T_{g} seen in the copolymer (FIG. 3A). The homopolymer blends prepared in the presence of either 5 or 10 wt % of the PCL/PU-1 block copolymer exhibited similar T_{g} values. These findings suggest that the homopolymers are miscible under these processing conditions, even in the absence of block copolymer. Transmission electron microscopy (TEM) of the cross-sections of these blends with and without the block copolymer incorporated also indicates that these blends are miscible, since only one phase is present even after staining the films with RuO₄ to enhance their contrast (FIGS. 12, 13). While staining the films with RuO₄ to evaluate heterogeneity in the blends, the degree of staining increased throughout the materials with increasing copolymer content (FIG. 3B). The film sample containing no copolymer turned slightly gray after 11 min of exposure to a solution of RuO₄ and the films with 5 and 10 wt % of block copolymer incorporation were darker, going from dark gray for the 5 wt % sample to black for the 10 wt % sample under the same exposure to the RuO₄ solution. Staining of extruded PCL and extruded PU-1 demonstrated that this staining method stains crystalline materials more since extruded PCL turns black while the extruded PU-1 did not stain well, which has been noted for the staining of semi-crystalline materials.^{32,33} This staining behavior suggested that the copolymer imparts higher crystallinity due to an ease in nucleation of the crystallites during the extrusion process.

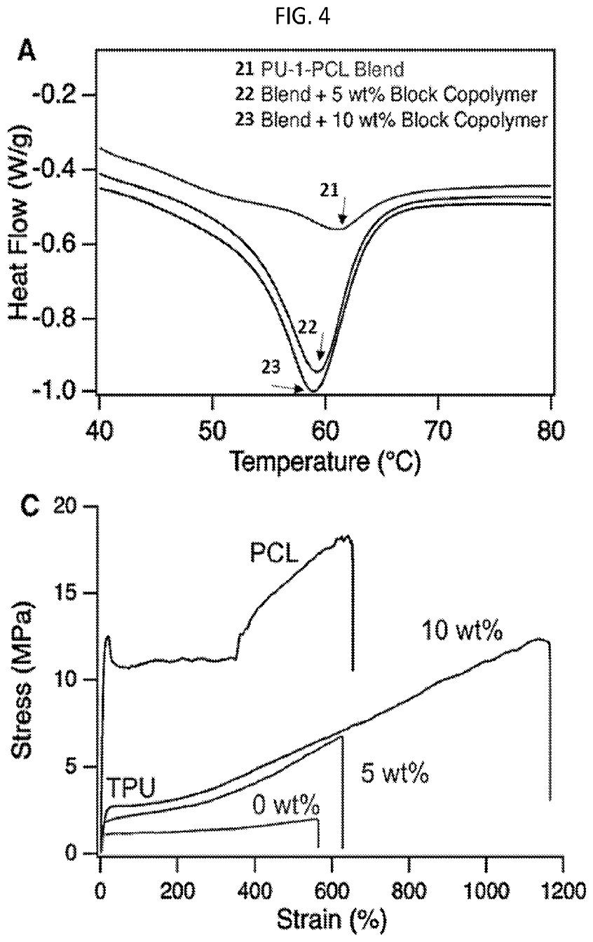

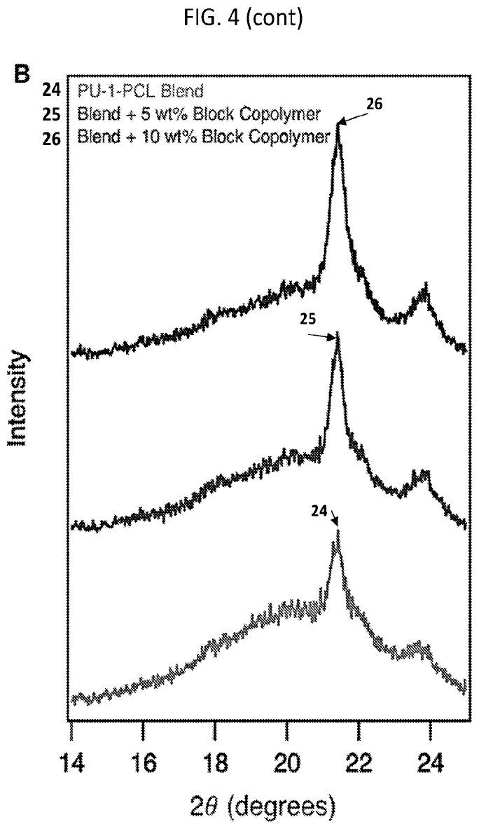

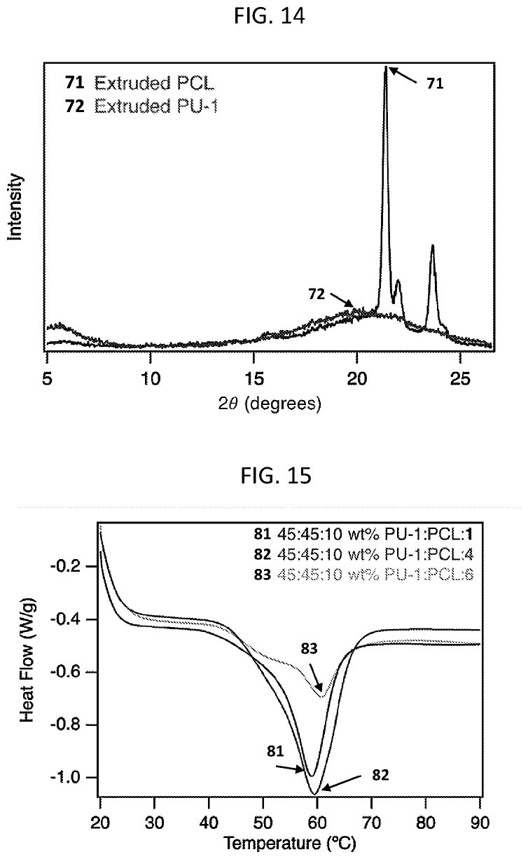

After analyzing the miscible blends with different amounts of block copolymer 1, a greater amount of copolymer incorporated was found to yield a blend with greater crystallinity after extrusion. DSC analysis of these extruded blends corroborated this effect of added block copolymer (FIG. 4A). On the initial heat ramp during the DSC procedure, endotherms resulting from the melting of crystallites were found starting at 55° C. for all compositions. However, the magnitude of the enthalpy differs with the three blends, suggesting different degrees of crystallinity, which is consistent with the staining behavior. The enthalpy for the melting transition for the 0 wt % blend was 7 J/g, compared to an enthalpy of 24 J/g for the 5 wt % blend and 27 J/g for the 10 wt % blend, supporting that the blends containing block copolymer are more crystalline. X-ray diffraction (XRD) analysis further confirmed that the blends with higher weight percent block copolymer are more crystalline due to a higher intensity diffraction pattern that corresponds to the PCL crystalline regimes (FIG. 4B). The extruded PCL and extruded blends contained peaks at 21.4 and 23.6 degrees which correspond to the (110) and (200) Bragg diffraction peaks for PCL,³⁴ while the extruded PU-1 is amorphous (FIG. 14). The blend without any block copolymer showed a lower intensity diffraction compared to the blends containing block copolymer as well as a larger broad amorphous feature. These analyses demonstrated that the extruded blends containing block copolymer are more crystalline through better nucleation of the PCL regimes in the blend.

The enhanced crystallinity from the block copolymer incorporation in the PU-1/PCL blends resulted in higher quality elastomeric materials with better mechanical properties (FIG. 4D, Table 3). Without block copolymer, the 50:50 blend had undesirable tensile properties when compared to the starting films of PCL and PU-1. This 0 wt % blend had a tensile stress of 1.6±0.4 MPa, strain at break of 500±100%, and a Young's modulus of 30±10 MPa. Films that contained 5 wt % of block copolymer 1 had enhanced mechanical properties compared to the 0 wt % samples with a tensile stress 8±1 MPa, a strain at break of 670±50%, and a Young's modulus of 21±6 MPa. Adding 10 wt % of block copolymer 1 yielded samples with higher strains at break (1000±200%), tensile stresses (14±3 MPa), and Young's Moduli (40±10 MPa). In order to better compare these materials' properties, toughness measurements were taken for each sample showing that the addition of the block copolymer increases the toughness from 600±200 J/m³ for the 0 wt % blend to 2300±900 J/m³ for the 5 wt % blend and finally increases to 7000±2000 J/m³ with 10 wt % blend. Incorporating the PE-PU block copolymer into blends of PE and PU thermoplastics enhances the mechanical toughness of these blends. Tensile testing showed the enhancement of the mechanical properties in the blends containing block copolymer from the crystallinity through better nucleation of the PCL chains during extrusion.

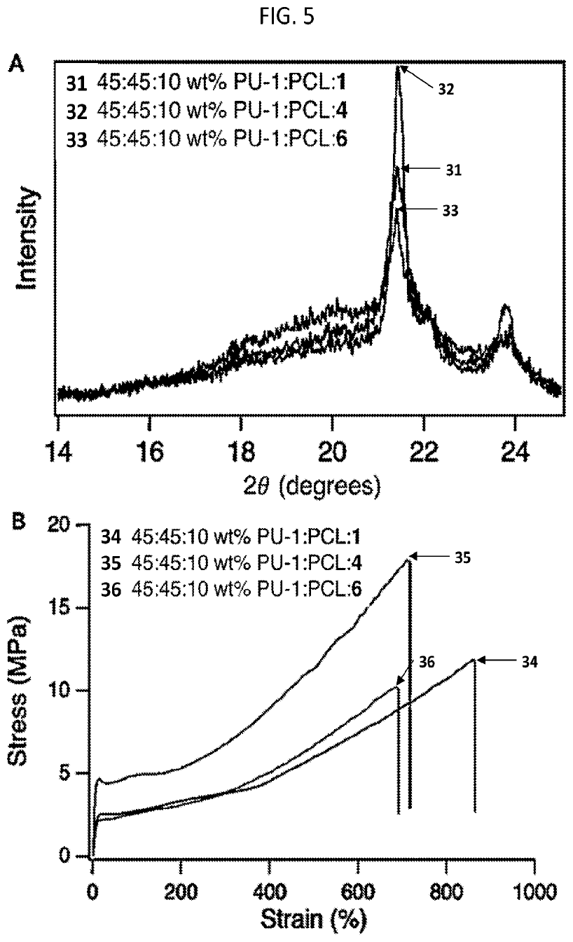

The copolymers showed differences in crystallinity and mechanical properties when incorporated into PU-1: PCL blends. Copolymers with more random structures resulted in enhanced crystallinity and higher toughness, but copolymers extruded for too long showed inferior properties, presumably because of their reduced molecular weight (FIG. 5). 10 wt % each of 1, 4, or 6 were incorporated into an identical 50:50 blend of PU-1 and PCL. XRD analysis of the blends containing each copolymer demonstrated the change in crystallinity with differing block copolymers (FIG. 5A). The blend containing 4 was the most crystalline with the highest intensity peaks of any of the blends. We hypothesize that the random structure of the copolymer allows the material to nucleate PCL crystallites more efficiently than the block copolymer with the shorter residence time. The blend containing 6 had the least amount of crystallinity with the least intense peaks as a result of the lowered molecular weight of the copolymer after these longer residence times. The crystallinity differences between the three 10 wt % blends were also evident from the magnitude of the initial melting endotherms by DSC (FIG. 15). Incorporation of copolymer 4 increased the tensile stress from 14±3 MPa for the copolymer 1 blend to 18±2 MPa (FIG. 5B, Table 4). However, the tensile strain at break decreased to 700±100% while the Young's modulus increased to 90±20 MPa. The tensile properties of the blend copolymer 6 were reduced compared to the blend containing 4 and the blend containing 1. The addition of copolymers with near-random structure demonstrated that the randomness of the copolymer enhanced the mechanical toughness of the blend due to increased crystallinity. However, if the copolymer has a low molecular weight, the property enhancement from the copolymer may not be observed.

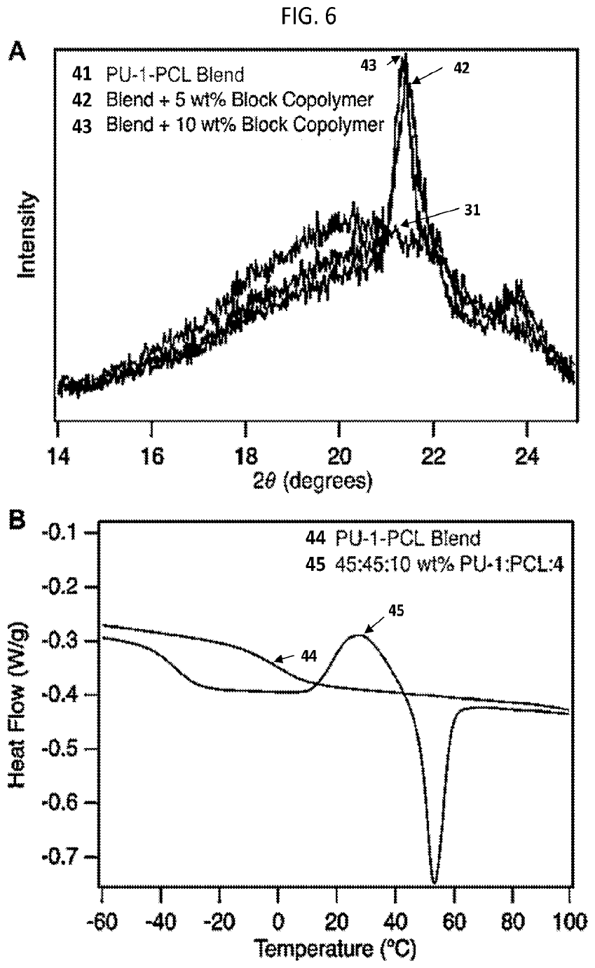

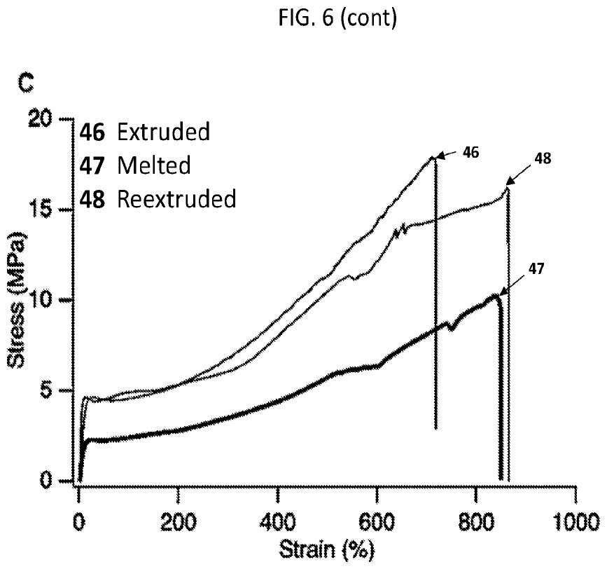

When the blends were heated past the melting temperature, the blends containing the copolymers retained some crystallinity due to a cold crystallization transition that allows for partial retention of the mechanical properties (FIG. 6). DSC of the blends demonstrated an endothermic melting transition but not an exothermic crystallization transition when cooled back down. However, XRD of the DSC samples after the heat treatment showed that the samples containing copolymer 1 (5 and 10 wt %) remained semi-crystalline while the blend not containing copolymer was not crystalline (FIG. 6A). The XRD spectrum for the blend without copolymer contained only a broad amorphous feature with no peaks. The blends with 5 and 10 wt % of copolymer 1 both contained peaks at similar 20 positions as PCL and the original extruded blends. The partial crystallinity in the heat-treated blends containing copolymer despite no crystallization temperature in the DSC arises from the ability of those blends to undergo cold crystallization at elevated temperatures above the T_{g} (FIG. 6B), which has been shown previously for blends containing PCL.³⁵ This feature was seen in the second heat ramp of the DSC trace with an onset temperature of 9.5° C. resulting in crystallization and subsequent melting that is not seen in the trace for the blend without copolymer. Cold crystallization occurs when the polymer chains are able to move at temperatures above the T_{g} resulting in nucleation and crystallization of the polymer chains. It is believed that the copolymer allows for enhanced motion of the chains at these elevated temperatures leading to this transition and reformation of the crystallites. However, the enthalpy of melting after this cold crystallization event was 16 J/g for the blend containing copolymer 4, which is significantly less than the 45 J/g melting enthalpy seen during the initial heating of the extruded blend via DSC (Table 5). Tensile testing comparing the originally extruded blend containing the blend containing 4 to the heat-treated blend, which was melted by heating to 120° C. and shaped into a tensile sample, showed that the crystallization via cold crystallization process occurs to a lesser extent than that which occurs upon coextrusion (FIG. 6C). The tensile stress of the heat-treated sample was reduced to 10.2 MPa and the strain at break was 838%. However, these properties were still superior to those of the homopolymer blend without copolymer. Overall, copolymer incorporation not only imparts better mechanical properties and crystallinity on the blends but allows them to cold crystallize at elevated temperatures allowing for partial crystallinity retention after heating.

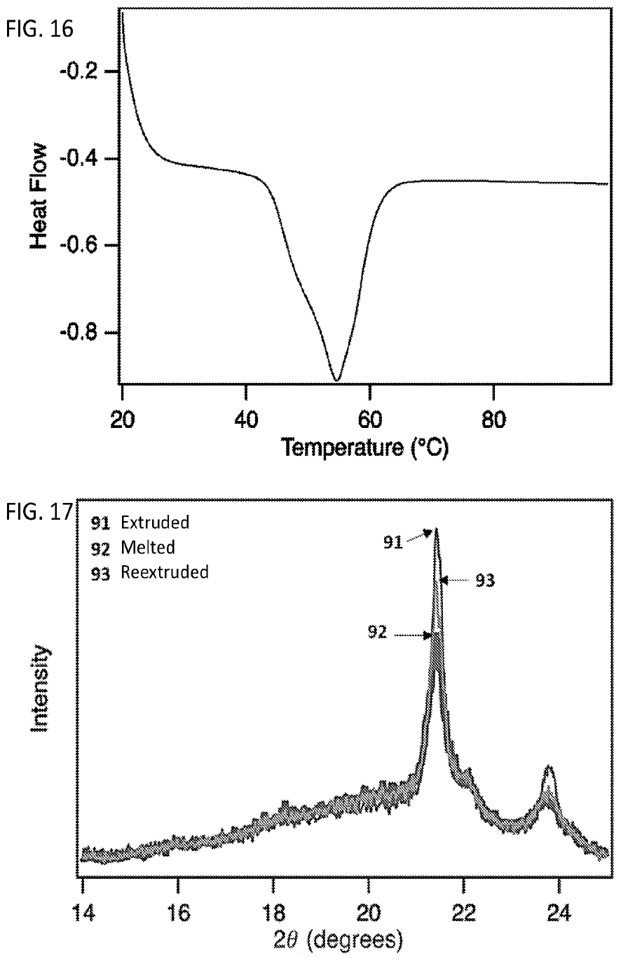

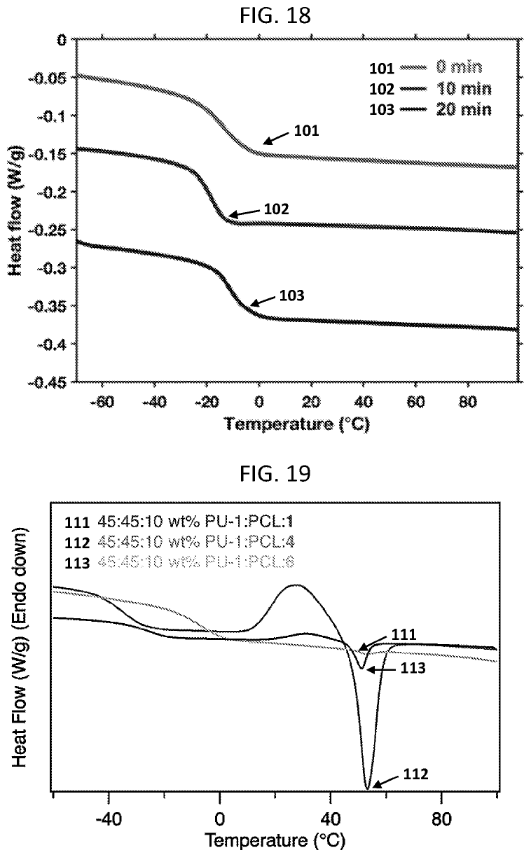

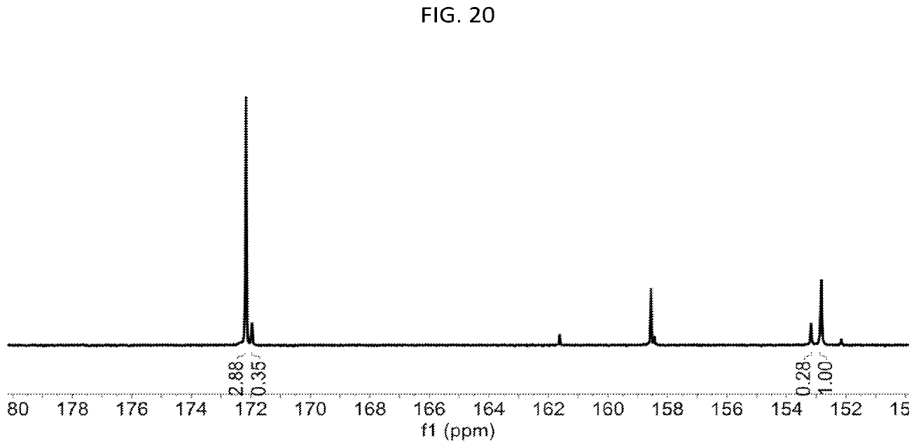

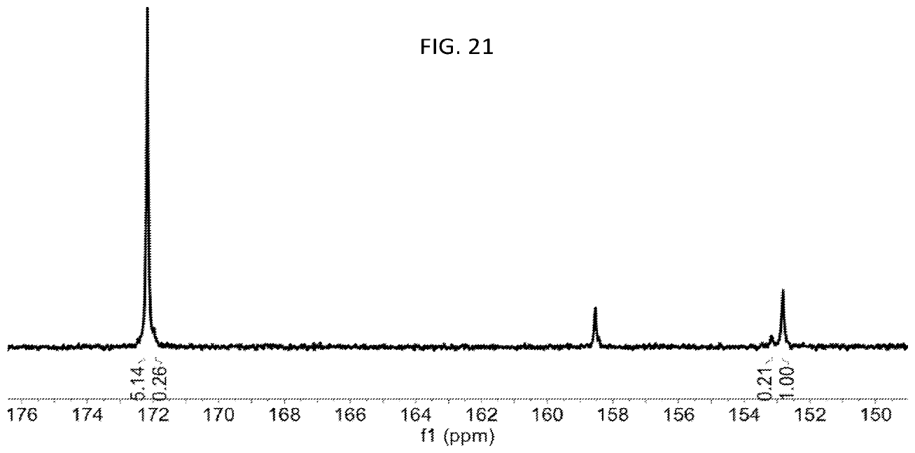

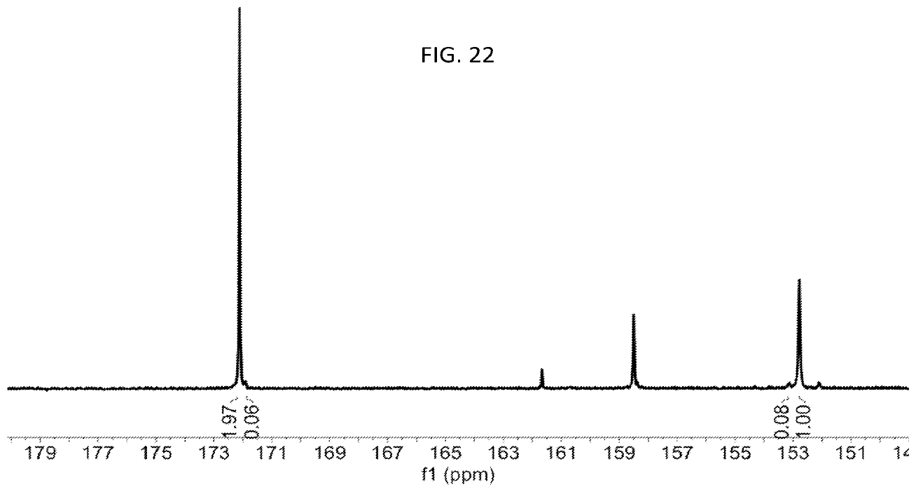

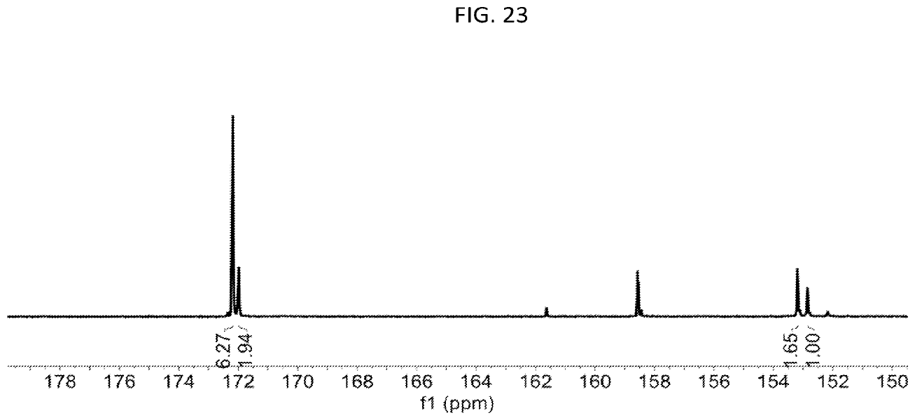

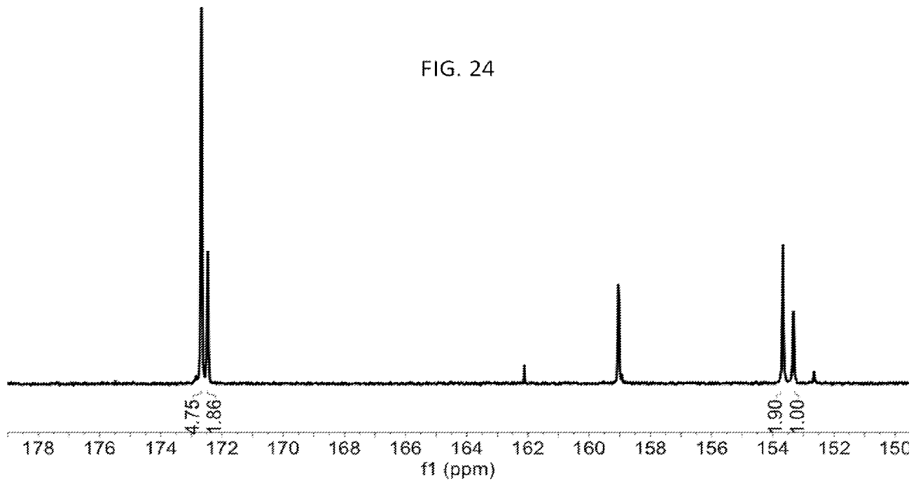

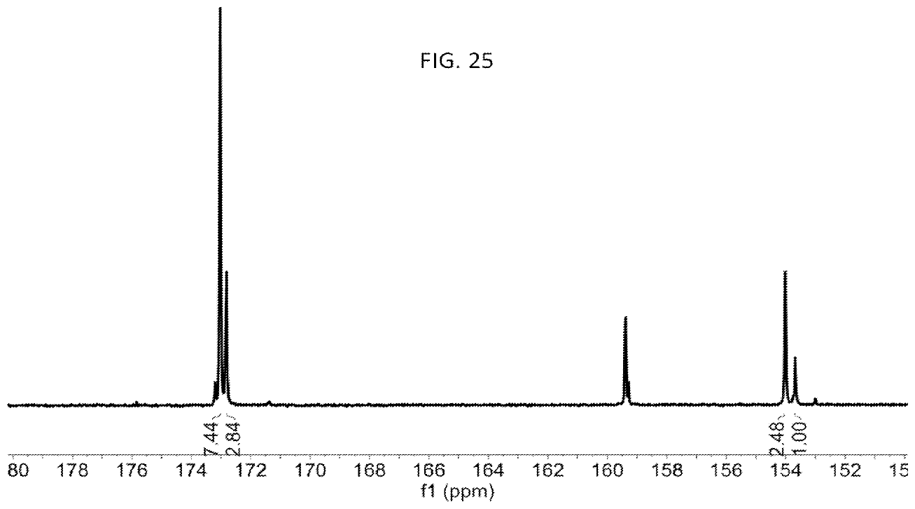

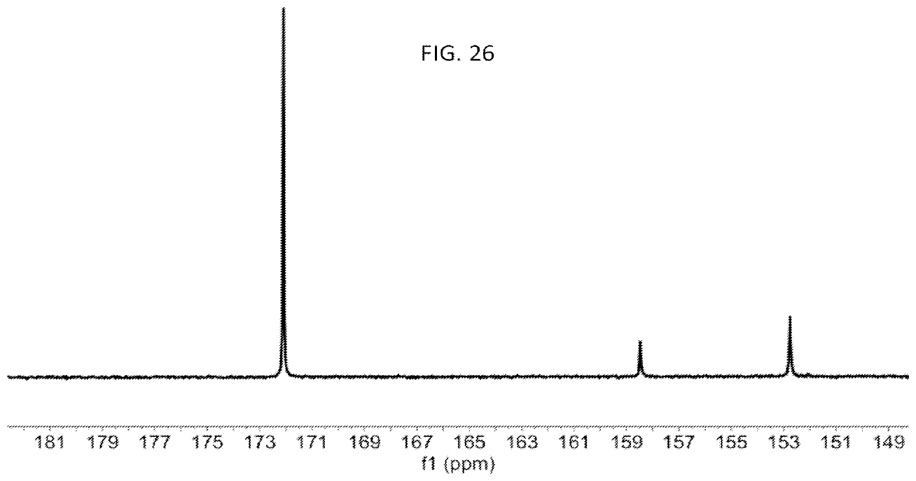

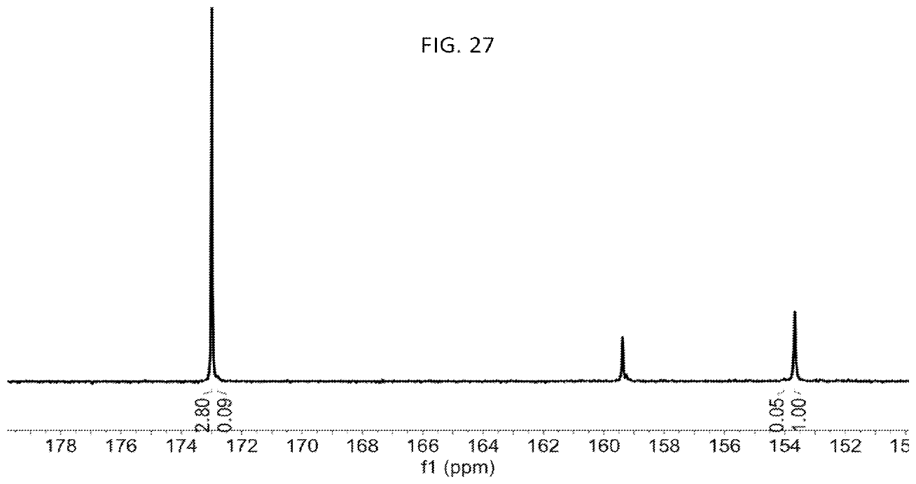

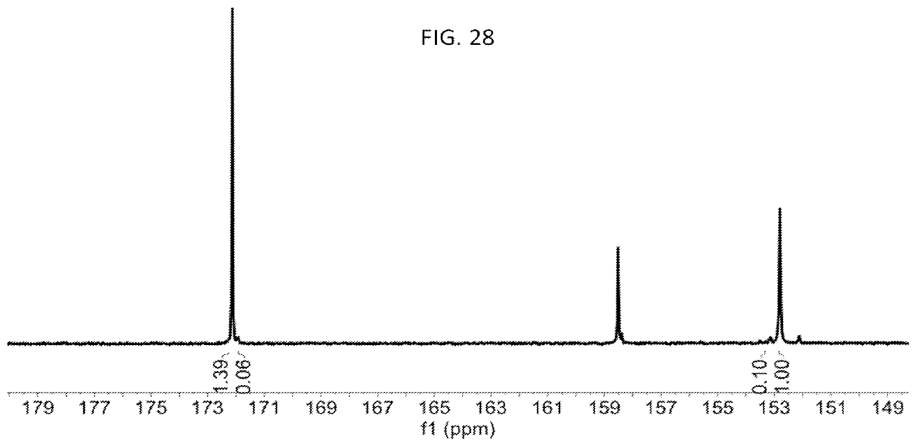

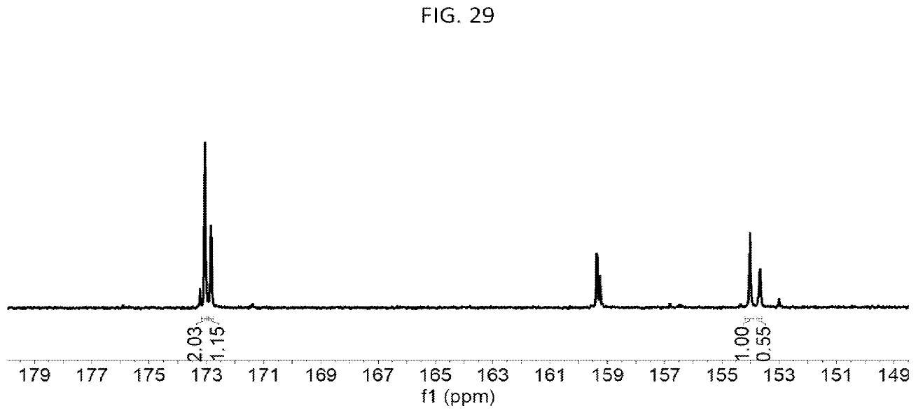

The ability of the PCL/PU-1 copolymers to enhance the crystallinity of the homopolymer blends during the extrusion was further confirmed by performing multiple melting and extrusion cycles. The extruded 50:50 blend of the two homopolymers and copolymer 4 (10 wt %) was melted at 120° C. and then reextruded. The tensile properties of the blend were largely recovered after reextruding the blend under the same conditions as those used in their original mixing. DSC also shows that the crystallinity can be mostly recovered by reextrusion with the melting enthalpy in the initial heating ramp being 29 J/g compared to 45 J/g of the originally extruded blend (FIG. 16). XRD also shows this trend in crystallinity through the different processing steps with the crystallinity decreasing after heat treatment then increasing after reextrusion (FIG. 17). Overall, blends containing the copolymers are able to recover the mechanical properties that were partially lost after heat-treatment through reextrusion under the same conditions as the initial processing of the blends.

The Examples demonstrate two complementary technologies: dynamic exchange in polymer solids and the use these exchange reactions to access copolymers as readily available property enhancement agents in polymer compositions. The Examples demonstrate twin-screw extrusion transformed solid PCL and PU-1 into block copolymers, whose structures were analyzed using quantitative solution ¹³C NMR to assess the degree of exchange during extrusion in the presence of a transesterification/transcarbamoylation catalyst. Extrusion allowed us to vary a range of processing conditions to investigate the effect that reaction time, catalyst loading, and temperature had on the polymer microstructure. Longer residence times in the extruder led to tunable copolymer structure from block copolymers to random copolymers, which were unambiguously characterized by quantitative ¹³C NMR spectroscopy. With an understanding of the microstructure, we were able to demonstrate that these polymers can serve as readily available property enhancers for miscible PCL/TPU blends. The copolymers enhanced the nucleation of the PCL crystallites in the miscible blends, resulting in improved mechanical properties. The more random copolymers enhanced the mechanical properties more effectively than block copolymers derived from lower extrusion times. The copolymer addition also allowed for retained crystallinity after heating the sample past the melting temperature through cold crystallization. Straightforward methods to characterize new copolymers, with tunable structures, will have many downstream uses. This approach represents a direct way to investigate catalysts for covalent adaptable networks. 36-38 Additionally, this method opens up the possibility of enhancing more commercial miscible blends of polymers. Custom PU-1 was synthesized to give maximal chemical shift difference with commercial PCL. However, with the high resolution of quantitative ¹³C NMR spectroscopy, dramatic differences in chemical shift are not required. Commercial polymers, including polyurethanes, polyesters, polycarbonates, and other polymers containing reactive chemical moieties may all be eligible to blend.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

(1) Singh, N.; Hui, D.; Singh, R.; Ahuja, I. P. S.; Feo, L.; Fraternali, F. Recycling of Plastic Solid Waste: A State of Art Review and Future Applications. Compos. Part B Eng. 2017, 115, 409-422.
(2) Siddiqui, J.; Pandey, G. A Review of Plastic Waste Management Strategies. Int. Res. J. Environ. Sci. Int. Sci. Congr. Assoc. 2013, 2 (12), 84-88.
(3) Budsaereechai, S.; Hunt, A. J.; Ngernyen, Y. Catalytic Pyrolysis of Plastic Waste for the Production of Liquid Fuels for Engines. RSC Adv. 2019, 9 (10), 5844-5857.
(4) Rahimi, A. R.; Garciá, J. M. Chemical Recycling of Waste Plastics for New Materials Production. Nat. Rev. Chem. 2017, 1, 1-11.
(5) Helms, B. A.; Russell, T. P. Reaction: Polymer Chemistries Enabling Cradle-to-Cradle Life Cycles for Plastics. Chem 2016, 1 (6), 816-818.
(6) Garcia, J. M.; Robertson, M. L. The Future of Plastics Recycling. Science (80-.). 2017, 358 (6365), 870-872.
(7) Tullo, A. H. Plastic Has a Problem; Is Chemical Recycling the Solution? Chem. Eng. News 2019, 97 (39).
(8) Wahab, D. A.; Hussain, A.; Scavino, E.; Mustafa, M. M.; Basri, H. Development of a Prototype Automated Sorting System for Plastic Recycling D. A. Wahab, A. Hussain, E. Scavino, M. M. Mustafa and H. Basri. 2006, 3 (7), 1924-1928.
(9) Utracki, L. A. Economics of Polymer Blends. Polym. Eng. Sci. 1982, 22 (17), 1166-1175.
(10) Suarez, H.; Barlow, J. W.; Paul, D. R. Mechanical-Properties of Abs Polycarbonate Blends. J. Appl. Polym. Sci. 1984, 29, 3253-3259.
(11) Cruz, C. A.; Barlow, J. W.; Paul, D. R. The Basis for Miscibility in Polyester-Polycarbonate Blends. Macromolecules 1979, 12 (4), 726-731.
(12) Sailer, C.; Handge, U. A. Reactive Blending of Polyamide 6 and Styrene-Acrylonitrile Copolymer: Influence of Blend Composition and Compatibilizer Concentration on Morphology and Rheology. Macromolecules 2008, 41 (12), 4258-4267.
(13) Yin, Z.; Koulic, C.; Pagnoulle, C.; Jérôme, R. Reactive Blending of Functional PS and PMMA: Interfacial Behavior of in Situ Formed Graft Copolymers. Macromolecules 2001, 34 (15), 5132-5139.
(14) Macosko, C. W.; Jeon, H. K.; Hoye, T. R. Reactions at Polymer-Polymer Interfaces for Blend Compatibilization. Prog. Polym. Sci. 2005, 30 (8-9), 939-947.
(15) Kim, H. J.; Peng, X.; Shin, Y.; Hillmyer, M. A.; Ellison, C. J. Blend Miscibility of Poly (Ethylene Terephthalate) and Aromatic Polyesters from Salicylic Acid. J. Phys. Chem. B 2021, 125 (1), 450-460.
(16) Bates, C. M.; Maher, M. J.; Janes, D. W.; Ellison, C. J.; Willson, C. G. Block Copolymer Lithography. Macromolecules 2014, 47, 2-12.
(17) Trimbach, D.; Feldman, K.; Spencer, N. D.; Broer, D. J.; Bastiaansen, C. W. M. Block Copolymer Thermoplastic Elastomers for Microcontact Printing. Langmuir 2003, 19 (26), 10957-10961.
(18) Hillmyer, M. A. Block Copolymer Synthesis. Curr. Opin. Solid State Mater. Sci. 1999, 4, 559-564.
(19) Anastasaki, A.; Oschmann, B.; Willenbacher, J.; Melker, A.; Van Son, M. H. C.; Truong, N. P.; Schulze, M. W.; Discekici, E. H.; McGrath, A. J.; Davis, T. P.; Bates, C. M.; Hawker, C. J. One-Pot Synthesis of ABCDE Multiblock Copolymers with Hydrophobic, Hydrophilic, and Semi-Fluorinated Segments. Angew. Chemie—Int. Ed. 2017, 56 (46), 14483-14487.
(20) Boyer, C.; Soeriyadi, A. H.; Zetterlund, P. B.; Whittaker, M. R. Synthesis of Complex Multiblock Copolymers via a Simple Iterative Cu(0)-Mediated Radical Polymerization Approach. Macromolecules 2011, 44 (20), 8028-8033.
(21) Gody, G.; Barbey, R.; Danial, M.; Perrier, S. Ultrafast RAFT Polymerization: Multiblock Copolymers within Minutes. Polym. Chem. 2015, 6 (9), 1502-1511.
(22) Macosko, C. W.; Guégan, P.; Khandpur, A. K.; Nakayama, A.; Marechal, P.; Inoue, T. Compatibilizers for Melt Blending: Premade Block Copolymers. Macromolecules 1996, 29 (17), 5590-5598.
(23) Mayo, F. R.; Lewis, F. M. Copolymerization. I. A Basis for Comparing the Behavior of Monomers in Copolymerization; The Copolymerization of Styrene and Methyl Methacrylate. J. Am. Chem. Soc. 1944, 66 (9), 1594-1601.
(24) Lutz, J. F.; Kirci, B.; Matyjaszewski, K. Synthesis of Well-Defined Alternating Copolymers by Controlled/Living Radical Polymerization in the Presence of Lewis Acids. Macromolecules 2003, 36 (9), 3136-3145.
(25) Klimovica, K.; Pan, S.; Lin, T.-W.; Peng, X.; Ellison, C. J.; Lapointe, A. M.; Bates, F. S.; Coates, G. W. Compatibilization of IPP/HDPE Blends with PE-g-IPP Graft Copolymers. ACS Macro Lett. 2020, 9 (8), 1161-1166.
(26) Kim, J.; Gray, M. K.; Zhou, H.; Nguyen, S. T.; Torkelson, J. M. Polymer Blend Compatibilization by Gradient Copolymer Addition during Melt Processing: Stabilization of Dispersed Phase to Static Coarsening. Macromolecules 2005, 38 (4), 16-19.
(27) Eagan, J. M.; Xu, J.; Di Girolamo, R.; Thurber, C. M.; Macosko, C. W.; La Pointe, A. M.; Bates, F. S.; Coates, G. W. Combining Polyethylene and Polypropylene: Enhanced Performance with PE/IPP Multiblock Polymers. Science (80-.). 2017, 355 (6327), 814-816.
(28) Fortman, D. J.; Sheppard, D. T.; Dichtel, W. R. Reprocessing Cross-Linked Polyurethanes by Catalyzing Carbamate Exchange. Macromolecules 2019, 52 (16), 6330-6335.
(29) Sheppard, D. T.; Jin, K.; Hamachi, L. S.; Dean, W.; Fortman, D. J.; Fortman, D. J.; Ellison, C. J.; Dichtel, W. R. Reprocessing Postconsumer Polyurethane Foam Using Carbamate Exchange Catalysis and Twin-Screw Extrusion. ACS Cent. Sci. 2020, 6 (6), 921-927.
(30) Yang, Y.; Xue, M.; Xiang, J. F.; Chen, C. F. Noncovalent Synthesis of Shape-Persistent Cyclic Hexamers from Ditopic Hydrazide-Based Supramolecular Synthons and Asymmetric Induction of Supramolecular Chirality. J. Am. Chem. Soc. 2009, 131 (35), 12657-12663.
(31) Houghton, R. P.; Mulvaney, A. W. Mechanism of Tin (IV)-Catalysed Urethane Formation. J. Organomet. Chem. 1996, 518 (1-2), 21-27.
(32) Loo, Y. L.; Register, R. A.; Adamson, D. H. Direct Imaging of Polyethylene Crystallites within Block Copolymer Microdomains. J. Polym. Sci. Part B Polym. Phys. 2000, 38 (19), 2564-2570.
(33) Wang, B., Li, B.; Xiong, J.; Li, C. Y. Hierarchically Ordered Polymer Nanofibers via Electrospinning and Controlled Polymer Crystallization. Macromolecules 2008, 41 (24), 9516-9521.
(34) Allo, B. A.; Rizkalla, A. S.; Mequanint, K. Synthesis and Electrospinning of ε-Polycaprolactone-Bioactive Glass Hybrid Biomaterials via a Sol-Gel Process. Langmuir 2010, 26 (23), 18340-18348.
(35) Herrera, D.; Zamora, J. C.; Bello, A.; Grimau, M.; Laredo, E.; Müller, A. J.; Lodge, T. P. Miscibility and Crystallization in Polycarbonate/Poly (ε-Caprolactone) Blends: Application of the Self-Concentration Model. Macromolecules 2005, 38 (12), 5109-5117.
(36) Kloxin, C. J.; Scott, T. F.; Adzima, B. J.; Bowman, C. N. Covalent Adaptable Networks (CANs): A Unique Paradigm in Cross-Linked Polymers. Macromolecules 2010, 43 (6), 2643-2653.
(37) Denissen, W.; Winne, J. M.; Du Prez, F. E. Vitrimers: Permanent Organic Networks with Glass-like Fluidity. Chem. Sci. 2016, 7 (1), 30-38.
(38) Fortman, D. J.; Brutman, J. P.; De Hoe, G. X.; Snyder, R. L.; Dichtel, W. R.; Hillmyer, M. A. Approaches to Sustainable and Continually Recyclable Cross-Linked Polymers. ACS Sustain. Chem. Eng. 2018, 6 (9), 11145-11159.

### EXAMPLES

### I. Materials and Methods

Materials. All reagents were purchased from Sigma-Aldrich or Fisher Scientific. All reagents were used without further purification unless otherwise specified. Dimethylformamide (DMF) and tetrahydrofuran (THF) were purchased from Fisher Scientific and purified using a custom-built alumina-column based solvent purification system. Other solvents were purchased from Fisher Scientific and used without further purification.

Methods. Nuclear Magnetic Resonance (NMR). ¹H and ¹³C NMR spectra were acquired on a Bruker AvanceIII-500 MHz spectrometer with a CryoProbe 5 mm DCH w/ Z-Gradient, or on a 400 MHz Agilent DD MR-400 spectrometer using an AutoX 5 mm probe w/ Z-Gradient. All spectra were recorded at 25° C. All spectra were calibrated using residual solvent as an internal reference (CDCl3: 7.26 ppm for ¹H NMR, 77.00 for ¹³C NMR; d₆-DMSO: 2.50 ppm for ¹H NMR, 39.52 ppm for ¹³C NMR).

Gel Permeation Chromatography (GPC) measurements were performed on a set of Phenomenex Phenogel 5m, 1K-75K, 300×7.80 mm in series with a Phenomex Phenogel 5m, 10K-1000K, 300×7.80 mm columns with HPLC grade solvents as eluents: dimethylformamide (DMF) with 0.05M of LiBr at 60° C. Detection consisted of a Wyatt Optilab T-rEX refractive index detector operating at 658 nm and a Wyatt DAWN® HELEOS® II light scattering detector operating at 659 nm.

Differential scanning calorimetry (DSC) was performed on a TA instruments Q1000 Differential Scanning calorimeter. Samples were heated at a rate of 10° C./min to at least 90° C. to erase thermal history, cooled to −30° C. at 10° C./min, and then heated to at least 120° C. All data shown are taken from the second heating ramp. The glass transition temperature (T_{g}) was calculated from the maximum value of the derivative of heat flow with respect to temperature.

Uniaxial tensile testing was conducted using dog bone shaped tensile bars (ASTM D-1708 1.0 mm (T)×5 mm (W)×25 mm (L) and a gauge length of 16 mm). The samples were aged for at least 48 h at ambient temperatures in a desiccator prior to testing. Tensile measurements were performed on a Sintech 20G tensile tester with 250 gram capacity load cell at ambient temperatures at a uniaxial extension rate of 5 mm/min. Young's modulus (E) values were calculated using the TestWorks software by taking the slope of the stress-strain curve from 0 to 1 N of force applied. Reported values are the averages and standard deviations of at least three replicates.

X-Ray Diffraction (XRD) patterns were obtained at room temperature on a STOE-StadiP powder diffractometer equipped with an asymmetric curved Germanium monochromator (CuKα1 radiation, λ=1.54056 Å) and one-dimensional silicon strip detector (MYTHEN2 1K from DECTRIS). The line focused Cu X-ray tube was operated at 40 kV and 40 mA. The as-obtained powder samples were sandwiched between two pieces of Kapton tape mounted in flat plates with a disc opening diameter of 3 mm and measured in transmission geometry in a rotating holder. The patterns were recorded in the 20 range of 5-29° for an overall exposure time of 18 min. The instrument was calibrated against a NIST Silicon standard (640d) prior to the measurement.

RuO₄ staining was performed through preparing a solution of RuCl in NaOCl (4-4.99% Cl) and letting sit for 2 hours until golden in color. The samples were then placed in the solution and allowed to sit at room temperature for 11 minutes. The samples were then removed and washed with water and allowed to dry overnight prior to imaging.

Microtomy was performed by mounting samples in a Leica UC7 Ultramicrotome fitted with an FC7 cryogenic stage (Leica Microsystems, Wetzlar, Germany). The diamond knives, sample, and chamber cooled down to-150C, and the sample block face was trimmed with a diamond trimming tool (DiATOME, Hatfield, PA, USA) to approximately 150 um×150 um. 100 nm thin sections were cut with a 35 degree cryo immune diamond knife (DiATOME, Hatfield, PA, USA) and collected on 300 mesh Cu grids with a 5-6 nm carbon membrane (Cat #CF300-Cu, Electron Microscopy Sciences, Hatfield, PA USA). The carbon membrane is in place to help with beam stability of the sample section in the electron microscope.

TEM was performed using a JEOL (JEOL USA, Inc., Peabody, MA) ARM200CF Aberration-Corrected STEM/TEM operated at 200 kV equipped with a Gatan (Gatan, Inc., Pleasanton, CA) OneView CMOS camera (FEG Emission: 15 μA, spot size 1, 150 μm CL aperture). All image acquisition was done using the Gatan Microscopy Suite (GMS), Digital Micrograph (Gatan, Inc., Pleasanton, CA).

Calculation of Block MW Based on Quantitative ¹³C NMR Spectra and Molecular Weight via GPC. The Mₙ of the total copolymer was computed from the GPC traces using a MALS detector and a calculated dn/dc of 0.087. As an example, for the copolymer prepared at 200° C. with 0.5 wt % DBTDL on purge (Table 1, Entry 1), the Mₙ was calculated to be 16.4 kDa.

When looking at the quantitative ¹³C NMR spectrum, the ratio of original PCL carbonyl signals to the new ester carbonyl signal is 8.33:1, corresponding to 9.33 units of caprolactone (MW=114.14 Da) in a block. For the original PU carbonyl signal to the new PU, the ratio is 3:1. Note that in every repeat unit in PU-1 (MW=526.64 Da), there are two urethane signals. The average MW for the PCL block is 1065 Da, and the average MW for the PU blocks is 1033 Da.

### II. Experimental Section

### Alkylation of Diester.

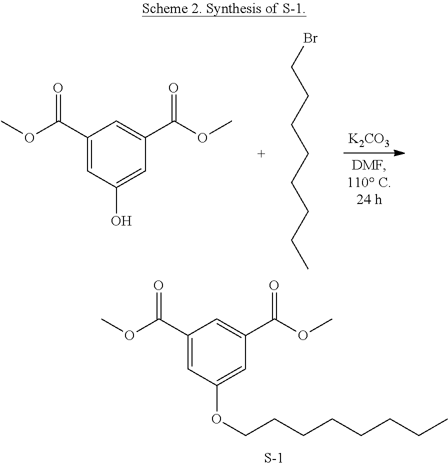

Dimethyl 5-hydroxyisophalate (35 g, 167 mmol) was dissolved in DMF (555 mL). To this, K₂CO₃ (69 g, 500 mmol, 3 equiv) and 1-bromooctane (36.2 mL, 208 mmol, 1.25 equiv) were added to the solution. The solution was heated to 110° C. for 24 h. The resulting solution was then cooled to room temperature and the solid was filtered off. The solution was concentrated in vacuo and the resulting oil was dissolved in DCM (500 mL). The organic layer was washed with 2 M HCl (2×, 500 mL) and brine (300 mL). The organic layer was dried with Na₂SO₄ and the DCM was removed in vacuo. The resulting solid was recrystallized from hot MeOH.

¹H NMR (500 MHz, d6-DMSO): δ 8.06 (t, J=1.45 Hz, 1H), 7.65 (d, J=1.45 Hz, 2H), 4.08 (t, J=6.45 Hz, 2H), 3.89 (s, 6H), 1.73 (p, J=7 Hz, 2H), 1.42 (p, J=7.3 Hz, 2H), 1.26 (m, 8H), 0.86 (t, J=6.8 Hz) ppm.

¹³C NMR (125 MHz, d6-DMSO): δ 165.68, 159.42, 131.96, 122.06, 119.66, 68.69, 53.02, 31.70, 29.16, 29.12, 28.92, 25.84, 22.57, 14.43 ppm.

### Reduction of S-1.

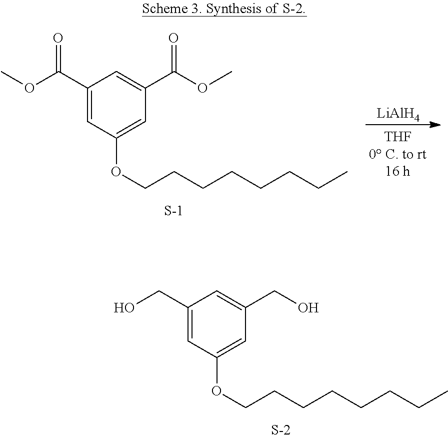

To a flame-dried round bottom flask, S-1 (20 g, 62 mmol) was dissolved in dry THF (200 mL). To this solution, LiAlH₄ (4.94 g, 130.3 mmol, 2.1 equiv) was added slowly at 0° C. The reaction was allowed to stir for 16 h at room temperature. After 16 h, the reaction was quenched slowly with water then 2 M HCl to dissolve the resulting lithium salts. The product was extracted with diethyl ether and the organic layers were combined and concentrated in vacuo to yield S-2 as a white powder (13.4 g, 81% yield).

¹H NMR (500 MHZ, d6-DMSO): δ 6.82 (s, 1H), 6.72 (s, 2H), 5.12 (t, J=5.71 Hz, 2H), 4.43 (d, J=6.00 Hz, 4H), 3.92 (t, J=6.47 Hz, 2H), 1.69 (m, 2H), 1.40 (m, 2H), 1.28 (m, 8H), 0.86 (t, J=6.74 Hz, 3H) ppm.

¹³C NMR (125 MHz, CDCl₃): δ 159.44, 142.80, 117.33, 111.99, 67.96, 65.88, 64.85, 31.83, 29.37, 29.28, 29.26, 26.05, 25.59, 22.67, 15.23, 14.11 ppm.

### Synthesis of Thermoplastic Polyurethane (PU-1)

PU-1 was prepared according to Scheme 1. S-2 (8 g, 30 mmol) was dissolved in THF (200 mL). To this, 4,4′-methylenediphenyl diisocyanate (MDI, 7.52 g, 30 mmol) was added and dissolved. DBTDL (190 mg, 1 mol %) was added and the solution was stirred and heated to 60° C. for 16 h. The resulting solution was precipitated in MeOH and the polymer was filtered and collected as a white powder.

¹H NMR (500 MHZ, CDCl3): δ 9.96 (s, 2H), 7.36 (d, 4H), 7.08 (d, 4H), 7.00 (s, 1H), 6.92 (s, 2H), 5.09 (s, 4H), 3.94 (m, 2H), 3.77 (s, 2H), 1.68 (m, 2H), 1.37 (m, 2H), 1.24 (m, 8H), 0.83 (m, 3H) ppm.

¹³C NMR (125 MHz, CDCl₃): δ 158.81, 153.11, 137.82, 136.50, 135.08, 128.45, 118.97, 118.13, 113.16, 67.39, 67.12, 65.30, 31.33, 28.65, 26.56, 28.54, 25.38, 21.96, 13.59 ppm. GPC (DMF): Mₙ: 22,110 g/mol; Ð: 1.33

### Synthesis of PCL/PU-1 Copolymers Using Twin-Screw Extrusion.

In a typical synthesis, a 50 wt % sample of PU-1 (2 g) and PCL (Mn=80,000 g/mol, 2 g) were combined in a vial and vortexed. To this, DBTDL (0.5 or 1 wt %) was added and the sample was vortexed again. The mixture was then fed into the microcompounder at 200° C. at 150 rpm. The samples were either flushed from the microcompounder or recirculated for 10, 20, or 30 min.

### NMR Sample Preparation for Quantitative ¹³C NMR.

80 mg of copolymer was dissolved in 0.7 mL of a 50:50 volume ratio of d6-DMSO and CDCl3 with a few microliters of TMS added. To this, 0.1 mL of a 0.2 mM solution of Cr (acac) 3 in DMSO: CDCl3.

### Preparation of PCL/PU-1 Compatibilized Blends.

A 50:50 weight percent mixture of PCI and TPU were vortexed along with 0, 5, or 10 wt % of block copolymer. The solid mixture was then fed into the microcompounder at 120° C. at 50 rpm on flush. The resulting films were used for tensile testing and microscopy analysis.

### III. Data Tables

TABLE 2
Calculation of block length and number of blocks for the
different block copolymers synthesized from extrusion.

| | PCL Block MW | PU-1 Block MW |
|---|---|---|
| Entry From Table 1 | (Da) | (Da) |
| 1 | 1065 | 1033 |
| 2 | 2371 | 1517 |
| 3 | 3862 | 3555 |
| 4 | 483 | 423 |
| 5 | 406 | 402 |
| 6 | 413 | 370 |
| 7 | N/A | N/A |
| 8 | 3663 | 5530 |
| 9 | 2758 | 2896 |
| 10 | 316 | 408 |

TABLE 3
Tensile properties of compatibilized PCL/TPU materials with
differing weight percentages of block copolymer incorporated.

| | Young's | | |
|---|---|---|---|
| | Modulus | Tensile | Strain at |
| Sample | (MPa) | Stress (MPa) | Break (%) |
| No Block | 27 ± 10 | 1.5 ± 0.4 | 500 ± 120 |
| Copolymer | | | |
| 5 wt % Block | 21 ± 6 | 8 ± 1 | 670 ± 50 |
| Copolymer | | | |
| 10 wt % Block | 36 ± 14 | 14 ± 3 | 1000 ± 150 |
| Copolymer | | | |

TABLE 4
Tensile properties of compatibilized PCL/PU-1 blends using
copolymers from extrusion of differing recirculation times.

| | Young's | | |
|---|---|---|---|
| | Modulus | Tensile | Strain at |
| Sample | (MPa) | Stress (MPa) | Break (%) |
| 10 wt % flush | 36 ± 14 | 14 ± 3 | 1000 ± 150 |
| BCP | | | |
| 10 wt % 10 | 90 ± 24 | 18 ± 2 | 680 ± 130 |
| min BCP | | | |
| 10 wt % 30 | 36 ± 10 | 10 ± 1 | 740 ± 50 |
| min BCP | | | |

TABLE 5
DSC data for the PU-1/PCL blends.

| Sample (BCP | | | ΔH_{melting, initial} | ΔH_{melting, coldcrystallization} |
|---|---|---|---|---|
| wt %) | T_{g} (° C.) | T_{m, onset} (° C.) | (J/g) | (J/g) |
| 0 wt % | −0.28 | 43.1 | 7.47 | N/A |
| 5 wt % | −15.5 | 52.1 | 23.7 | N/A |
| 10 wt % flush | −26.56 | 52.3 | 27.3 | 3.66 |
| 10 wt % 10 min | −33.16 | 50.2 | 44.6 | 15.7 |
| 10 wt % 30 min | −7.47 | 51.9 | 18.0 | 0.40 |

TABLE 6
Mₙ and dispersity values calculated for reprocessed
copolymers. All polymers reprocessed at 200°
C. with varying amounts of DBTDL as catalyst.

| Entry in | Recirculation | Cat. Amount | Mn, GPC | |
|---|---|---|---|---|
| Table 1 | Time (min) | (wt %) | (kDa) | Dispersity |
| 1 | 0 | 0.5 | 16.4 | 1.72 |
| 2 | 0 | 1 | 10.5 | 1.43 |
| 3 | 10 | 0.5 | 17.1 | 1.44 |
| 4 | 20 | 0.5 | 17.9 | 1.59 |
| 5 | 30 | 0.5 | 5.9 | 1.81 |
| 10 | 0 | 0 | 32.5 | 1.47 |

1. A method for preparing a copolymer, the method comprising compounding a bond-exchange catalyst and a polymer composition comprising a first homopolymer and a second homopolymer at an effective bond-exchange temperature for an effective bond-exchange time in a compounder, thereby preparing a compounded melt; and
extruding the compounded melt from the compounder.

2. The method of claim 1, wherein the weight percent (wt %) of the first homopolymer is between 20 and 80 wt % and the weight percent of the second homopolymer is between 20 and 80 wt % in the polymer composition.

3. The method of claim 1, wherein the effective bond-exchange time prepares a block copolymer.

4. The method of claim 1, wherein the effective bond-exchange time prepares a random copolymer.

5. The method of claim 1, wherein the first homopolymer is a polyurethane homopolymer and the second homopolymer is a polyester homopolymer.

6. The method of claim 5, wherein the weight percent (wt %) of the polyurethane homopolymer is between 20 and 80 wt % and the weight percent of the polyester homopolymer is between 20 and 80 wt % in the polymer composition.

7. The method of claim 5, wherein the effective bond-exchange time prepares a polyurethane/polyester block copolymer.

8. The method of claim 5, wherein the effective bond-exchange time prepares a polyurethane/polyester random copolymer.

9. The method of claim 1, wherein the effective bond-exchange time is from about 1 to 60 minutes.

10. The method of claim 1, wherein the effective bond-exchange temperature is about 100 to 300° C.

11. The method of claim 1, wherein the amount of catalyst is about 0.1 to 5.0 wt %.

12. The method of claim 1, wherein the bond-exchange catalyst comprises a metal selected from Sn, Bi, Fe, Zr, Ti, Hf, Al, Zn, Cu, Ni, Co, Mₙ, V, Sc, Y, Ce, or Mo and a ligand coordinated with the metal atom.

13. The method of claim 12, wherein the carbamate exchange catalyst comprises dibutyltin dilaurate (DBTDL), Bi(neo)₃, Fe(acac)₃, Ti(OiPr)₂(acac)₂, Hf(acac)₄, Zr(acac)₄, Mₙ(acac)₂, Bi(oct)₃, Zn(tmhd)₂, Zr(tmhd)₄, or any combination thereof.

14. The method of claim 12, wherein the carbamate exchange catalyst is dibutyltin dilaurate (DBTDL).

15. The method of claim 1, wherein the first homopolymer comprises a blend of different first homopolymers and/or the second homopolymer comprises a blend of different second homopolymers.

16. The method of claim 1, wherein the first homopolymer and/or the second homopolymer is a foam.

17. The method of claim 1, wherein the first homopolymer and/or the second homopolymer is a network polymer.

18. The method of claim 1, wherein the first homopolymer and the second homopolymer in the polymer composition are miscible.

19. The method of claim 1, wherein the polymer composition is a polymer blend.

20. A method for preparing a compatibilized blend, the method comprising compounding the copolymer prepared by the method according to claim 1 and a second polymer composition at a compatibilization temperature for a compatibilization time in a compounder, thereby a compatibilized blend; and
extruding the compatibilized blend from the compounder.

21. (canceled)

22. (canceled)

23. (canceled)

24. (canceled)

25. (canceled)

26. (canceled)

27. (canceled)

28. (canceled)
